(19) United States
(12) Patent Application Publication
(10) Pub. No.: US 2024/0357399 A1
(43) Pub. Date: Oct. 24, 2024

(54) REMOTE INTERFERENCE DETECTION BASED ON MACHINE LEARNING

(71) Applicant: QUALCOMM Incorporated, San Diego, CA (US)

(72) Inventors: Yuwei REN, Beijing (CN); Xipeng ZHU, San Diego, CA (US); Huilin XU, Temecula, CA (US); June NAMGOONG, San Diego, CA (US)

(21) Appl. No.: 18/682,312

(22) PCT Filed: Oct. 8, 2021
(86) PCT No.: PCT/CN2021/122595

§ 371 Date: Feb. 8, 2024

(51) Int. Cl. H04W 24/10; H04L 41/16

(52) U.S. Cl. CPC H04W 24/10; H04L 41/16

(57) ABSTRACT

Methods, systems, and devices for wireless communications are described. The method may include a wireless device (e.g., a user equipment (UE) or a base station) receiving, from a network node, a machine learning model for use by the wireless device to detect remote interference from a base station. The wireless device may be associated with a first cell and the base station may be associated with a second cell different from the first cell. The wireless device may input one or more parameters into the machine learning model and detect whether the remote interference from the base station is present based on an output of the machine learning model.

### CROSS REFERENCE

The present application is a 371 national stage filing of International PCT Application No. PCT/CN2021/122595 by REN et al. entitled “REMOTE INTERFERENCE DETECTION BASED ON MACHINE LEARNING,” filed Oct. 8, 2021, which is assigned to the assignee hereof, and which is expressly incorporated by reference in its entirety herein.

### FIELD OF TECHNOLOGY

The following relates to wireless communications, including remote interference detection based on machine learning.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some examples, a wireless device (e.g., a base station or a UE) may experience remote interference. As an example, remote interference may occur when a downlink signal from a base station travels outside of the base station's cell into the cell of another base station due to atmospheric ducting. The downlink signal may arrive at the other base station cell during an uplink transmission time period and therefore, block uplink signals to the other base station. Using other methods, an operator may manually detect remote interference by inspecting a slope of the received power at the other base station.

### SUMMARY

The described techniques relate to improved methods, systems, devices, and apparatuses that support remote interference detection based on machine learning. Generally, the described techniques provide for a wireless device (e.g., a base station or a user equipment (UE)) utilizing machine learning to detect remote interference. In some examples, the wireless device may receive control signaling, from a network node, including one or more machine learning models for remote interference detection. The wireless device may input parameters (e.g., an energy waveform of a received signal, a weather condition, etc.) into at least one machine learning model of the one or more machine learning models and the at least one machine learning model may output at least an indication of whether remote interference is detected. If the wireless device detects remote interference based on the output of the machine learning model, the wireless device may perform a remote interference mitigation procedure with one or more base stations that may be predicted to cause the detected remote interference.

A method for wireless communication at a first wireless device is described. The method may include receiving, at the first wireless device from a network node, a machine learning model for use by the first wireless device to detect remote interference from a base station, where the first wireless device is associated with a first cell and the base station is associated with a second cell different from the first cell, inputting, by the first wireless device, one or more parameters into the machine learning model, and detecting, by the first wireless device, whether the remote interference from the base station is present based on an output of the machine learning model, the output based on the one or more parameters input into the machine learning model.

An apparatus for wireless communication at a first wireless device is described. The apparatus may include a processor, memory coupled with the processor, and instructions stored in the memory. The instructions may be executable by the processor to cause the apparatus to receive, at the first wireless device from a network node, a machine learning model for use by the first wireless device to detect remote interference from a base station, where the first wireless device is associated with a first cell and the base station is associated with a second cell different from the first cell, input, by the first wireless device, one or more parameters into the machine learning model, and detect, by the first wireless device, whether the remote interference from the base station is present based on an output of the machine learning model, the output based on the one or more parameters input into the machine learning model.

Another apparatus for wireless communication at a first wireless device is described. The apparatus may include means for receiving, at the first wireless device from a network node, a machine learning model for use by the first wireless device to detect remote interference from a base station, where the first wireless device is associated with a first cell and the base station is associated with a second cell different from the first cell, means for inputting, by the first wireless device, one or more parameters into the machine learning model, and means for detecting, by the first wireless device, whether the remote interference from the base station is present based on an output of the machine learning model, the output based on the one or more parameters input into the machine learning model.

A non-transitory computer-readable medium storing code for wireless communication at a first wireless device is described. The code may include instructions executable by a processor to receive, at the first wireless device from a network node, a machine learning model for use by the first wireless device to detect remote interference from a base station, where the first wireless device is associated with a first cell and the base station is associated with a second cell different from the first cell, input, by the first wireless device, one or more parameters into the machine learning model, and detect, by the first wireless device, whether the remote interference from the base station is present based on an output of the machine learning model, the output based on the one or more parameters input into the machine learning model.

Some examples of the method, apparatuses, and non-transitory computer-readable medium described herein may further include operations, features, means, or instructions for transmitting, to the network node and after detecting whether the remote interference from the base station may be present, one or more indications that indicate the one or more parameters input into the machine learning model, the output of the machine learning model, or any combination thereof.

Some examples of the method, apparatuses, and non-transitory computer-readable medium described herein may further include operations, features, means, or instructions for receiving, after detecting whether the remote interference from the base station may be present, a reference signal from the base station based on transmitting the one or more indications and determining whether the output of the machine learning model may be accurate based on the reference signal.

Some examples of the method, apparatuses, and non-transitory computer-readable medium described herein may further include operations, features, means, or instructions for transmitting, to the network node after determining whether the output of the machine learning model may be accurate, an indication of whether the output of the machine learning model may be accurate.

Some examples of the method, apparatuses, and non-transitory computer-readable medium described herein may further include operations, features, means, or instructions for receiving, from the network node, an updated version of the machine learning model, the updated version of the machine learning model based on the one or more parameters input into the machine learning model, the output of the machine learning model, one or more second parameters input into respective machine learning models implemented at one or more second wireless devices, one or more respective second outputs of the respective machine learning models obtained by the one or more second wireless devices, or any combination thereof.

Some examples of the method, apparatuses, and non-transitory computer-readable medium described herein may further include operations, features, means, or instructions for selecting a time resource, a frequency resource, or both for an uplink transmission based on detecting whether the remote interference from the base station may be present.

In some examples of the method, apparatuses, and non-transitory computer-readable medium described herein, the one or more parameters include an energy waveform parameter for a signal received at the first wireless device over a duration, a date, a time, an uplink reception rate in one or more uplink symbols, a location of the first wireless device, a weather condition, a frequency resource or a time resource corresponding to a failed uplink transmission, or any combination thereof.

In some examples of the method, apparatuses, and non-transitory computer-readable medium described herein, the one or more parameters includes the energy waveform parameter for the signal and the duration includes one or more symbols between a first time period for downlink signaling within the first cell and a next time period for downlink signaling within the first cell.

In some examples of the method, apparatuses, and non-transitory computer-readable medium described herein, the one or more parameters includes the energy waveform parameter for the signal, the energy waveform parameter including a slope of received power for the signal, an initial received power for the signal, or both.

In some examples of the method, apparatuses, and non-transitory computer-readable medium described herein, the output of the machine learning model includes an indication of whether the remote interference from the base station may be present, one or more identifiers associated with one or more base stations causing remote interference, a distance between the first wireless device and the base station, a direction of the remote interference from the base station, a quantity of the one or more base stations causing remote interference, or any combination thereof.

In some examples of the method, apparatuses, and non-transitory computer-readable medium described herein, the first wireless device includes a base station that provides service within the first cell or a UE communicating within the first cell.

A method for wireless communication at a network node is described. The method may include transmitting, to a first wireless device, a machine learning model for the first wireless device to detect remote interference from a base station, where the first wireless device is associated with a first cell and the base station is associated with a second cell different from the first cell, receiving, from the first wireless device, signaling that indicates one or more parameters input into the machine learning model by the first wireless device, an output of the machine learning model obtained by the first wireless device, or any combination thereof, and determining an updated version of the machine learning model based on the one or more parameters input into the machine learning model by the first wireless device, the output of the machine learning model obtained by the first wireless device, or any combination thereof.

An apparatus for wireless communication at a network node is described. The apparatus may include a processor, memory coupled with the processor, and instructions stored in the memory. The instructions may be executable by the processor to cause the apparatus to transmit, to a first wireless device, a machine learning model for the first wireless device to detect remote interference from a base station, where the first wireless device is associated with a first cell and the base station is associated with a second cell different from the first cell, receive, from the first wireless device, signaling that indicates one or more parameters input into the machine learning model by the first wireless device, an output of the machine learning model obtained by the first wireless device, or any combination thereof, and determine an updated version of the machine learning model based on the one or more parameters input into the machine learning model by the first wireless device, the output of the machine learning model obtained by the first wireless device, or any combination thereof.

Another apparatus for wireless communication at a network node is described. The apparatus may include means for transmitting, to a first wireless device, a machine learning model for the first wireless device to detect remote interference from a base station, where the first wireless device is associated with a first cell and the base station is associated with a second cell different from the first cell, means for receiving, from the first wireless device, signaling that indicates one or more parameters input into the machine learning model by the first wireless device, an output of the machine learning model obtained by the first wireless device, or any combination thereof, and means for determining an updated version of the machine learning model based on the one or more parameters input into the machine learning model by the first wireless device, the output of the machine learning model obtained by the first wireless device, or any combination thereof.

A non-transitory computer-readable medium storing code for wireless communication at a network node is described. The code may include instructions executable by a processor to transmit, to a first wireless device, a machine learning model for the first wireless device to detect remote interference from a base station, where the first wireless device is associated with a first cell and the base station is associated with a second cell different from the first cell, receive, from the first wireless device, signaling that indicates one or more parameters input into the machine learning model by the first wireless device, an output of the machine learning model obtained by the first wireless device, or any combination thereof, and determine an updated version of the machine learning model based on the one or more parameters input into the machine learning model by the first wireless device, the output of the machine learning model obtained by the first wireless device, or any combination thereof.

Some examples of the method, apparatuses, and non-transitory computer-readable medium described herein may further include operations, features, means, or instructions for transmitting, to the base station and after receiving the signaling that indicates the one or more parameters input into the machine learning model, the output of the machine learning model, or any combination thereof, signaling that instructs the base station to transmit a reference signal to the first wireless device to evaluate whether the output of the machine learning model may be accurate.

Some examples of the method, apparatuses, and non-transitory computer-readable medium described herein may further include operations, features, means, or instructions for transmitting the updated version of the machine learning model to the first wireless device.

Some examples of the method, apparatuses, and non-transitory computer-readable medium described herein may further include operations, features, means, or instructions for receiving, from one or more second wireless devices, signaling that indicates one or more second parameters input into respective machine learning models implemented at the one or more second wireless devices, one or more respective outputs of the respective machine learning models obtained by the one or more second wireless devices, or any combination thereof.

Some examples of the method, apparatuses, and non-transitory computer-readable medium described herein may further include operations, features, means, or instructions for determining the updated version of the machine learning model may be further based on the one or more second parameters input into respective machine learning models implemented at the one or more second wireless devices, the one or more respective second outputs of the respective machine learning models obtained by the one or more second wireless devices, or any combination thereof.

In some examples of the method, apparatuses, and non-transitory computer-readable medium described herein, a first portion of the machine learning model may be for a set of wireless devices that includes the first wireless device, the one or more second wireless devices, and one or more additional wireless devices and a second portion of the machine learning model may be for a subset of the set of wireless devices, the subset including the first wireless device and the one or more second wireless devices.

In some examples of the method, apparatuses, and non-transitory computer-readable medium described herein, the output of the machine learning model obtained by the first wireless device and the one or more respective second outputs of the respective machine learning models obtained by the one or more second wireless devices may be each associated with the first portion of the machine learning model and each include an identifier associated with the base station.

Some examples of the method, apparatuses, and non-transitory computer-readable medium described herein may further include operations, features, means, or instructions for receiving, from the one or more additional wireless devices, signaling that indicates one or more third parameters input into respective machine learning models implemented at the one or more additional wireless devices, one or more respective third outputs of the respective machine learning models obtained by the one or more additional wireless devices, or any combination thereof, where determining the updated version of the machine learning model may include operations, features, means, or instructions for determining an updated version of the first portion of the machine learning model based on the one or more third parameters input into the respective machine learning models implemented at the one or more additional wireless devices, the one or more respective third outputs of the respective machine learning models obtained by the one or more additional wireless devices, or any combination thereof and determining an updated version of the second portion of the machine learning model independent of the one or more third parameters input into respective machine learning models implemented at the one or more additional wireless devices, the one or more respective third outputs of the respective machine learning models obtained by the one or more additional wireless devices, or any combination thereof, transmitting the updated version of the first portion of the machine learning model to each wireless device of the set of wireless devices, and transmitting the updated version of the second portion of the machine learning model to each wireless device of the subset of the set of wireless devices.

In some examples of the method, apparatuses, and non-transitory computer-readable medium described herein, the one or more parameters include an energy waveform parameter for a signal received at the first wireless device over a duration, a date, a time, an uplink reception rate in one or more uplink symbols, a location of the first wireless device, a weather condition, a frequency resource or a time resource corresponding to a failed uplink transmission, or any combination thereof.

In some examples of the method, apparatuses, and non-transitory computer-readable medium described herein, the output of the machine learning model includes an indication of whether the remote interference from the base station may be present, one or more identifiers associated with one or more base stations causing remote interference, a distance between the first wireless device and the base station, a direction of the remote interference from the base station, a quantity of the one or more base stations causing remote interference, or any combination thereof.

### BRIEF DESCRIPTION OF THE DRAWINGS

FIGS. 1, 2, and 3 illustrate examples of a wireless communications system that supports remote interference detection based on machine learning in accordance with aspects of the present disclosure.

FIG. 4 illustrates an example of a process flow that supports remote interference detection based on machine learning in accordance with aspects of the present disclosure.

FIGS. 5 and 6 show block diagrams of devices that support remote interference detection based on machine learning in accordance with aspects of the present disclosure.

FIG. 7 shows a block diagram of a communications manager that supports remote interference detection based on machine learning in accordance with aspects of the present disclosure.

FIG. 8 shows a diagram of a system including a user equipment (UE) that supports remote interference detection based on machine learning in accordance with aspects of the present disclosure.

FIG. 9 shows a diagram of a system including a base station that supports remote interference detection based on machine learning in accordance with aspects of the present disclosure.

FIGS. 10 and 11 show block diagrams of devices that support remote interference detection based on machine learning in accordance with aspects of the present disclosure.

FIG. 12 shows a block diagram of a communications manager that supports remote interference detection based on machine learning in accordance with aspects of the present disclosure.

FIG. 13 shows a diagram of a system including a device that supports remote interference detection based on machine learning in accordance with aspects of the present disclosure.

FIGS. 14 through 19 show flowcharts illustrating methods that support remote interference detection based on machine learning in accordance with aspects of the present disclosure.

### DETAILED DESCRIPTION

In some examples, a base station may transmit a downlink signal and the downlink signal may travel outside of the coverage area of the base station's cell (e.g., due to atmospheric ducting). In such an example, the downlink signal may reach the cell of another base station. Because the downlink signal may travel a large distance (e.g., 100 kilometers (kms) or more), the downlink signal may arrive at the other base station after some delay. If both base stations are operating according to the same time division duplexing (TDD) configuration, the delay may cause the downlink signal to arrive at the other base station during an uplink transmission and as such, the downlink signal may interfere with uplink signals sent to the other base station. The base station causing the interference may be referred to as the aggressor and the base station experiencing the interference may be referred to as the victim. An operator may observe an interference over thermal (IoT) slope to determine whether remote interference is occurring and manually initiate an interference mitigation procedure in the presence of remote interference. But manual inspection of remote interference may be inefficient and at times, inaccurate because the IoT slope may not provide an accurate indication of remote interference.

In some examples, the victim base station may implement machine learning to detect remote interference from one or more aggressor base stations. In one example, a network node may transmit signaling to the victim base station including one or more machine learning models, where each machine learning model may have a corresponding set of input parameters and output parameters. The set of input parameters for a machine learning model may include any combination of an energy waveform of a received signal, a date, a time, etc., and the set of output parameters may include any combination of an indication of whether remote interference is present, a number of aggressor base stations, identifier (IDs) associated with the aggressor base stations, etc. The victim base station may input the set of input parameters into a machine learning model and detect whether remote interference is occurring based on the output of the machine learning model, which may be a predication of whether the remote interference is occurring. If remote interference is detected, the victim base station may initiate the interference mitigation procedure as described above.

In some examples, upon determining the output of the machine learning model, the victim base station may send information related to the machine learning model to the network node (e.g., inputs and output of the machine learning model) and the network node may fuse this information with information received from other victim base station in the network to create an updated version of the machine learning model. The network node may then distribute the updated version of the machine learning model to victim base stations in the network, such that the victim base stations may be benefit from federated learning (e.g. distributed machine learning, with the model further trained based on information received from multiple victim base stations and then distributed to each of the multiple victim base stations). Additionally or alternatively, during the machine learning model training phase, the network node may enable the victim base station to exchange reference signals with the aggressor base station. This exchange of reference signals may allow the victim base station to corroborate the output of the machine learning model. Although examples herein may be described as with reference to victim base station, it is to be understood that the techniques described herein as performed by a victim base station may additionally or alternatively be performed by any wireless device that may experience remote interference (e.g. a victim user equipment (UE)). The methods as described herein may allow for increased efficiency and accuracy in predicting remote interference when compared to other methods.

Aspects of the disclosure are initially described in the context of wireless communications systems. Additional aspects of the disclosure are described in the context of a process flow. Aspects of the disclosure are further illustrated by and described with reference to apparatus diagrams, system diagrams, and flowcharts that relate to remote interference detection based on machine learning.

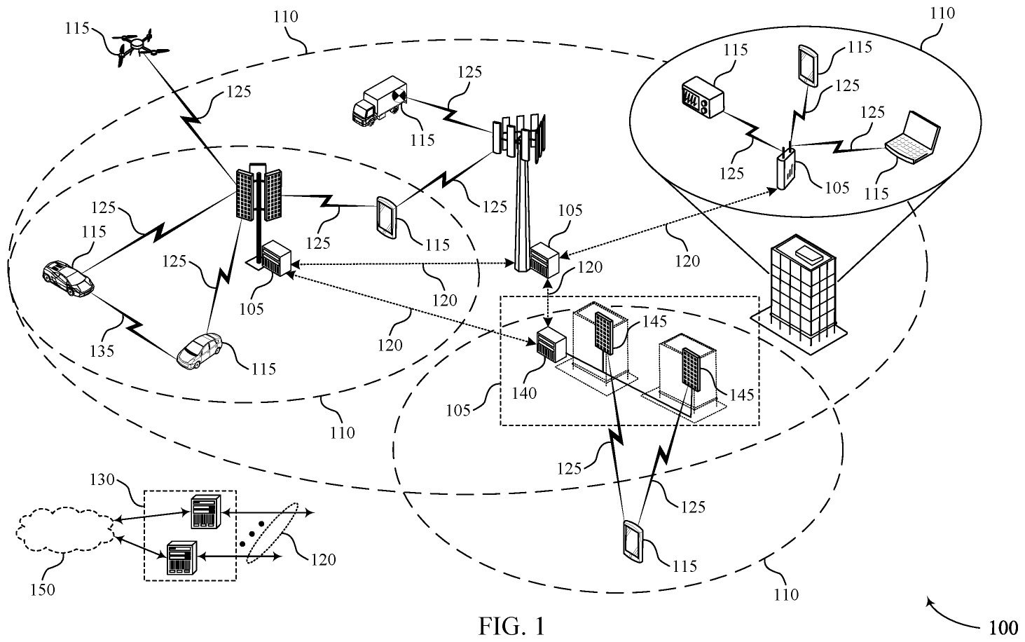

FIG. 1 illustrates an example of a wireless communications system 100 that supports remote interference detection based on machine learning in accordance with aspects of the present disclosure. The wireless communications system 100 may include one or more base stations 105, one or more user equipment (UEs) 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and TDD component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an ID for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, the wireless communications system 100 may support machine learning based remote interreference detection. A wireless device (e.g., the base station 105 or the UE 115) may receive control signaling, from a network node (e.g., the core network 130 or the access network entity 140), including one or more machine learning models for remote interference detection. The wireless device may input parameters (e.g., an energy waveform of a received signal, a weather condition, etc.) into a machine learning model of the one or more machine learning models and the machine learning model may output at least an indication (e.g., prediction) of whether remote interference is present. If the wireless device detects remote interference based on the output of the machine learning model, the wireless device may perform a remote interference mitigation procedure with one or more base station detected as causing the remote interference.

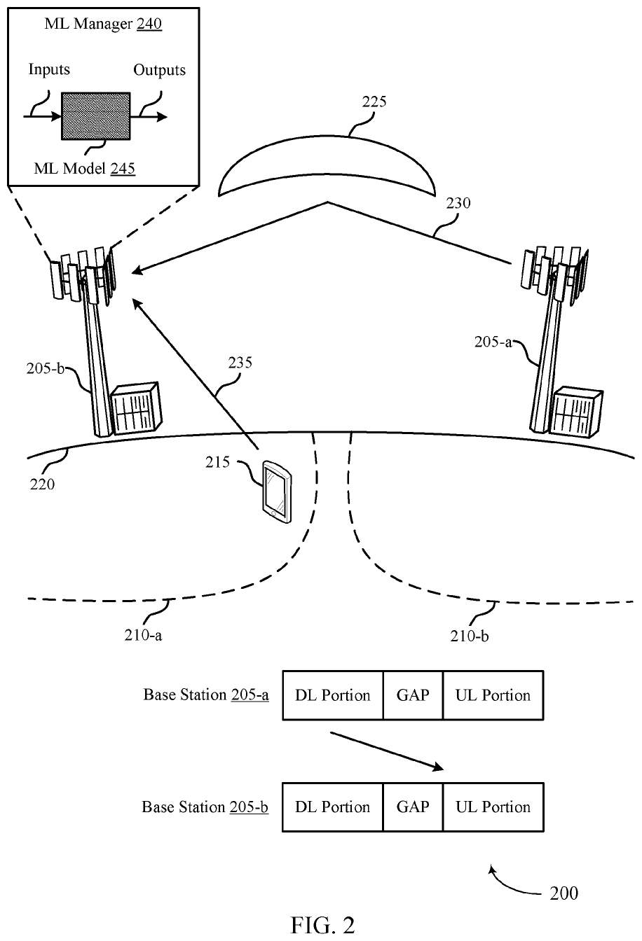

FIG. 2 illustrates an example of a wireless communications system 200 that supports remote interference detection based on machine learning in accordance with aspects of the present disclosure. In some examples, the wireless communications system 200 may implement aspects of a wireless communications system 100. For example, the wireless communications system 200 may include base stations 205 and a UE 215 which may be examples of base stations 105 and a UE 115 as described with reference to FIG. 1.

In some examples, remote interference may occur in the wireless communications system 200. For example, the base station 205-b may experience remote interference caused by the base station 205-a. The base station 205-a and the base station 205-b may be located a large distance (e.g., 200 to 400 kilometers) away from one another and as such, may support different cells 210 (or coverage areas). As an example, the base station 205-b may support a cell 210-a and the base station 205-a may support a cell 210-b. When the base station 205-a transmits a downlink signal 230, the downlink signal 230 may have the potential to reach the cell 210-a of the base station 205-b due to the existence of an atmospheric duct 225. An atmospheric duct 225 may be described as a horizontal layer in the lower atmosphere that tends to follow the curvature of the earth 220 and may cause a signal to reflect back towards the earth over great distances. In some examples, the base station 205-a and the base station 205-b may operate according to the same TDD configuration and as such, a downlink portion for the base station 205-a may occur at the same time as a downlink portion for the base station 205-b. The downlink portion may refer to a quantity of symbols that are reserved for downlink transmissions by the base station 205 In some examples, between each downlink portion there may be an uplink portion, where the uplink portion may refer to a quantity of symbols that are reserved for uplink transmissions to the base stations 205.

However, because the downlink signal 230 may travel for some distance before reaching the base station 205-b, there may a delay between the base station 205-a transmitting the downlink signal 230 and the downlink signal 230 reaching the cell 210-a. Due to this delay, the downlink signal 230 may arrive at the cell 210-a during the uplink portion of the base station 205-b and therefore, may interfere with any uplink signals intended for the base station 205-b (e.g., uplink signal 235 from the UE 215).

In some examples, the base station 205-b may perform a procedure to mitigate the remote interference caused by the base station 205-a. Using conventional techniques, an operator of the wireless communications system 200 may manually determine that remote interference is occurring at the base station 205-a by inspecting the received power at the base station 205-a offline. Remote interference (e.g., interference over thermal (IoT)) may result in a high received power (e.g., above a threshold) that gradually decreases over time. The received power may gradually decrease over time due to remote interference propagation (e.g., base stations 205 other than the base station 205-a contributing to the remote interference experienced at the base station 205-b). As such, the operator may inspect the received power over time (e.g., slope) to determine whether remote interference is occurring at the base station 205-b. If the operator determines that remote interference is occurring, the operator may trigger a remote interference procedure mitigation at the base station 205-a.

Using conventional methods, the base station 205-b may initiate the remote interference mitigation procedure by transmitting a first reference signal (e.g., RS-1) to the base station 205-a. Once the base station 205-a detects the first reference signal, the base station 205-a may apply remote interference mitigation schemes. As one example, the base station 205-a may reduce the power used for transmissions, change the direction of the beam used for transmissions, or adjust the timing of transmissions. The base station 205-a may then transmit a second reference signal (e.g., RS-2) to the base station 205-b according to the remote interference mitigation scheme. If the base station 205-b does not detect the second reference signal, the remote interference mitigation procedure may be deemed successful. If the base station 205-b does detect the reference signal, the remote interference mitigation procedure may be repeated until the base station 205-b does not detect the second reference signal. The method for detecting the remote interference as described above may not be accurate. For example, the received power over time may decrease due to factors other than remote interference and as such, the operator may determine there is remote interference when there is none. In such case, performing the interference mitigation procedure may waste valuable time and resources. In addition, because the operator must manually detect the remote interference, there may be some latency between detection of the remote interference and remote interference mitigation. During this latency, the base station 205-a may be unable to receive some or all uplink signals due to the remote interference. As such, other method for remote interference detection may be beneficial.

As described herein, a wireless device (e.g., the base station 205-b or the UE 215) may utilize machine learning to detect remote interference. Machine learning may provide a system the ability to learn and improve from experience. To support machine learning, the base station 205-b may include a machine learning manager 240 and may be configured with a set of one or more machine learning models 245. A machine learning model 245 may be described as a neural network that supports a particular machine learning function or algorithm. In some examples, the base station 205-b may receive the set of machine learning models 245 from a network node, e.g., via a backhaul link. Each machine learning model 245 of the set of machine learning models 245 may have a corresponding set of inputs and a corresponding set of outputs. Examples of potential inputs may be a received energy waveform over time in one or more symbols after a last downlink symbol of a downlink portion (e.g., a slope or a starting energy of the waveform), a date (e.g., a season), a time (e.g., daytime or nighttime), an abnormality in uplink reception rate in one or more uplink symbols, a location of the base station 205-b, a weather condition, historical data related to remote interference detection (e.g., a time or measurement pattern, weather information, or location information determined from the last remote interference measurement event or the IDs of the base stations causing or experiencing the remote inference during the last remote interference measurement event), or a combination thereof. Examples of potential outputs may be an indication of whether remote interference is detected (e.g., a prediction of whether remote interference is detected), a number of base stations 205 causing the remote interference, a direction of the incoming remote interference, IDs of the base stations 205 causing the remote interference, or a combination thereof.

As one example, a machine learning model of the set may have a weather condition as the input and an indication of whether remote interference is present as an output. In such example, the base station 205-b may detect that the weather condition is cloudy and input the weather condition into the machine learning model. The risk of remote interference may be higher during cloudy weather than other weather conditions (e.g., clear weather condition). As such, the machine learning model may output an indication that remote interference is detected.

As another example, a machine learning model of the set may have an abnormality in uplink reception rate in one or more uplink symbols as the input and an indication of whether remote interference is present as the output. The base station 205-b may determine that it has not detected or detected less often than usual a random access preamble from the UE 115 in the uplink portion or has not detected a scheduling request or a scheduled physical uplink shared channel (PUSCH) transmission from the UE 115 in the uplink portion. Remote interference may interfere with the base station 205-b's ability to receive uplink transmissions from the UE 115 and may be the cause of such abnormalities. As such, the machine learning model may output an indication that remote interference is detected. If the base station 205-b determines remote interference is present, the base station 205-b may perform the remote interference mitigation procedure as described above. Using the methods as described herein may allow a base station 205 to accurately and efficiently detect remote interference.

Additionally or alternatively, the UE 115 may utilize machine learning to detect remote interference. In one example, the UE 115 may receive the machine learning model 245 trained by the base station 205-b to detect remote interference. If the UE 115 detects remote interference using the trained machine learning model 245, the UE 115 may select uplink resources (e.g., for a random access procedure) as to avoid the remote interference. For example, the UE 115 may choose to transmit uplink signals over resources that are located a few symbols away from the symbols at the beginning of the uplink portion. In another example, the base station 205-b may be configured with a machine learning model 245 whose input may be uplink symbols where the UE 115 fails to transmit uplink control information (e.g., over the physical uplink control channel (PUCCH)), uplink data (e.g., over the PUSCH), or fails to perform random access. The UE 115 may determine the uplink symbols and store the uplink symbol information in its memory. Once the UE 115 connects to the network, the UE 115 may send the uplink symbol information to the base station 205-b and the base station 205-b may input the uplink symbol information into the machine learning model 245 to determine whether remote interference is occurring.

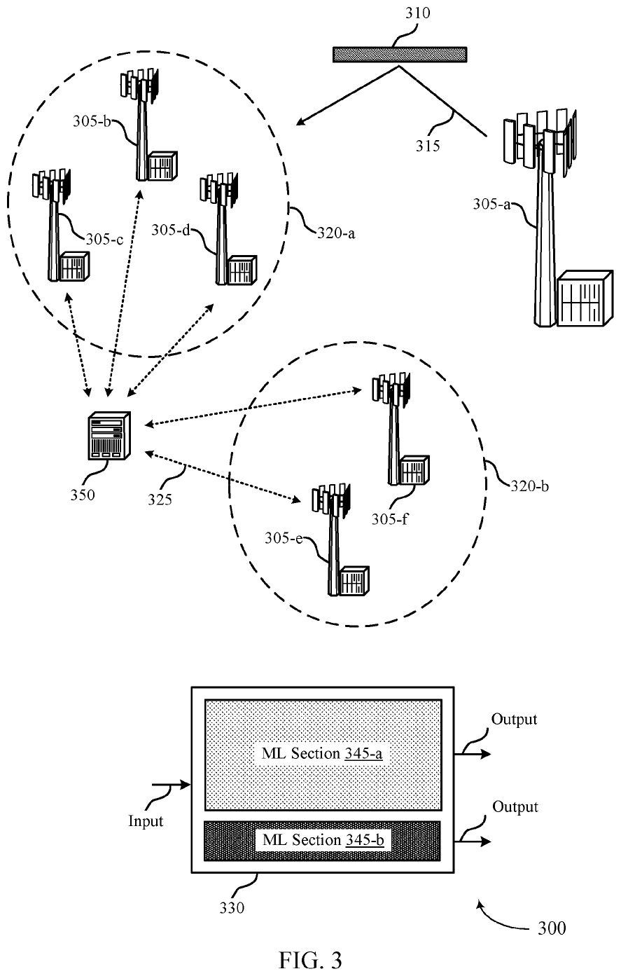

FIG. 3 illustrates an example of a wireless communications system 300 that supports remote interference detection based on machine learning in accordance with aspects of the present disclosure. In some examples, the wireless communications system 300 may implement aspects of a wireless communications system 100 and a wireless communications system 200. For example, the wireless communications system 300 may include base stations 305 which may be an example of base stations 105 and base stations 205 as described with reference to FIGS. 1 and 2.

As described in FIG. 2, a wireless device (e.g., the base station 305 or a UE) may be configured with one or more machine learning models 330 and utilize the one or more machine learning models 330 for remote interference detection. For example, multiple base stations 305 (e.g., a base station 305-b, a base station 305-c, a base station 305-d, a base station 305-e, and a base station 305-f) may be connected to a network node 350 via a respective backhaul link 325 and may be configured with a machine learning model 330 by the network node 350. The network node 350 may be an example of an operations, administration, and maintenance (OAM) node. The OAM may be responsible for provisioning and managing a network or an element within the network. Each base station 305 of the multiple base station 305 may improve or train the machine learning model 330 through experience. After some time (e.g., after some improvements have been made to the machine learning model or after detection of remote interference using the machine learning model), each base station 305 of the multiple base stations 305 may send information related to the machine learning model 330 to the network node 350. This information may include data inputted into the machine learning model 330 and data output from the machine learning model 330. The network node 350 may fuse this information together and send an updated machine learning model 330 to each of the multiple base stations 105 based on the fused information (e.g., perform federated learning). That is, a machine learning model 330 may be jointly trained based on data obtained from the multiple base stations 305 and the machine learning model 330 may be shared among the multiple base stations 305.

In some examples, different sections 345 of the machine learning model 330 may be shared among the multiple base stations 305. In one example, the multiple base stations 305 may be separated into groups 320. For example, the multiple base stations 305 may be separated into a group 320-a including the base station 305-b, the base station 305-c, and the base station 305-d and a group 320-b including the base station 305-e and the base station 305-f. Base stations 305 in the same group 320 may experience remote interference from the same base station 305. For example, the base stations 305 in the group 320-a may experience remote interference caused by an atmospheric duct 310 and a downlink signal 315 transmitted by the base station 305-a.

To determine which base stations 305 are in each group, the network node 350 may inspect the outputs of the machine learning model 330 of the multiple base stations 305. For example, the network node 350 may identify that the base station 305-b, the base station 305-c, and the base station 305-d output one or more of the same aggressor IDs (e.g., IDs of the base stations 305 causing the remote interference). The section 345-b of the machine learning model 330 may be responsible for predicting the one or more aggressor IDs, whereas the section 345-a of the machine learning model 330 may be responsible for all other outputs (e.g., indication of whether remote interference is present). As such, the base stations 305 of group 320-a may jointly train (or share) the section 345-b and the base stations of both the group 320-a and the group 320-b (or any other base stations 305 in the same network or network area) may jointly train (or share) the section 345-a. That is, base stations of the same group 320 may share the entire machine learning model 330 and base stations 305 across groups 320 may share portion of the machine learning model 330, where the portion excludes aggressor ID detection (e.g., ID of the base station 305 causing the interference).

Additionally or alternatively, during the model training phase, the network node 350 may enable one or more of the multiple base stations 305 to corroborate or validate the outputs of the machine learning models 330 or the machine learning model 330 as a whole using coherent remote interference detection. In one example, the base station 305-b may determine that the base station 305-a is the cause of remote interference at the base station 305-b using machine learning and send an indication that remote interference is detected to the network node 350. Upon receiving the indication, the network node 350 may instruct the base station 305-b to use the framework of the remote interference mitigation procedure as described in FIG. 2 to corroborate or validate the outputs of the machine learning model 330 or the machine learning model 330 as a whole. That is, the base station 305-b may transmit a first reference signal to the base station 305-a and the base station 305-a may transmit a second reference signal to the base station 305-b upon detecting the first reference signal. In some examples, the first reference signal may include an indication of the base station 305-b (e.g., an ID of the base station 305-b). The detection of the second reference signal at the base station 305-b may be used ground truth for the machine learning model 330. That is, if the base station 305-b detects the second reference signal then the base station 305-b may corroborate or validate the machine learning model 330. In some examples, the base station 305-b may transmit an indication to the network node indicating that the output of the machine learning model 330 is accurate.

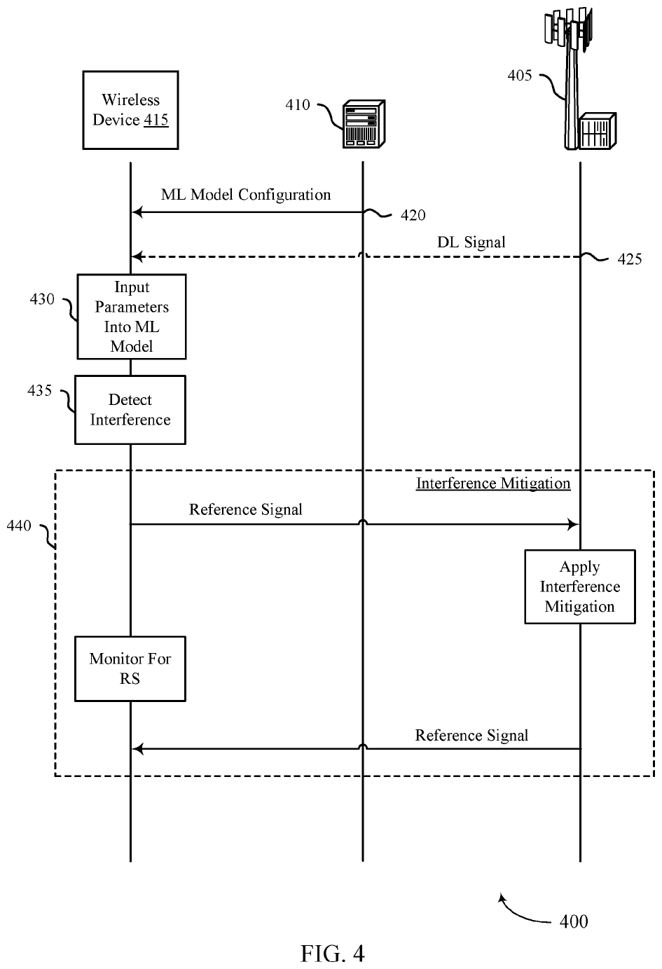

FIG. 4 illustrates an example of a process 400 that supports remote interference detection based on machine learning in accordance with aspects of the present disclosure. In some examples, the process flow 400 may implement aspects of a wireless communications system 100, a wireless communications system 200, and a wireless communications system 300. For example, the process flow 400 may include a base station 405, and a network node 410 which may be examples of a base stations 105, a base station 205, a base station 305, and a network node 350 as described with reference to FIGS. 1 through 3. A wireless device 415 may be an example of a base station or a UE. Alternative examples of the following may be implemented, where some steps are performed in a different order then described or are not performed at all. In some cases, steps may include additional features not mentioned below, or further steps may be added.

At 420, the wireless device 415 may receive, from the network node 410, signaling indicating one or more machine learning models for detecting remote interference. In some examples, each machine learning model may have a corresponding set of input parameters and a corresponding set of output parameters. The set of input parameters may be one or more of an energy waveform of a received signal over time within one or more uplink symbols after the last downlink symbols of a downlink portion, a date, a time, abnormalities in uplink symbols, a location of the wireless device 415, a weather condition (e.g., of a coverage area of the wireless device 415, a coverage area of the base station 405, or an area between the wireless device 415 and the base station 405), or historical remote interference event detection information and measurement results.

At 425, the base station 405 may potentially transmit a downlink signal. Due to atmospheric ducting, the downlink signal may travel to the wireless device 415 and may block an uplink signal to the wireless device 415. In some examples, the base station 405 may be located a distance away from the wireless device 415 and may support a different cell when compared to the wireless device 415.

At 430, the wireless device 415 may input parameters into the one or more machine learning models. In one examples, an input parameter for a machine learning model of the one or more machine learning models may be the energy waveform of the received signal over time and an output parameter for the machine learning model may be an indication that remote interference is present. At 415, the wireless device 415 may determine that the slope of the energy waveform in the first symbols of an uplink slot after a downlink portion is decreasing and the starting energy of the energy waveform is relatively high (e.g., above a threshold). The starting energy of the energy waveform may be relatively high because the wireless device 415 is receiving the downlink signal from the base station 405 and the slope of the energy waveform may decrease due to a propagation in remote interference. The wireless device 415 may input the information related to the energy waveform into the machine learning model and output an indication that remote interference is detected at the wireless device 415.

In some examples, after the wireless device 415 determines the output of the machine learning model, the wireless device 415 may send information related to the machine learning model to the network node 410. For example, the wireless device 415 may transmit the recent input values and output values of the machine learning model to the network node 410. In some examples, the network node 410 may fuse this information with information gathered from other wireless devices 415 and configure the wireless device 415 with an updated machine learning model or an updated portion of the machine learning model based on the fused information.

Additionally or alternatively, after the wireless device 415 determines the output of the machine learning model (e.g., during training), the network node 410 may enable the wireless device 415 to validate the machine learning model by exchanging reference signals with the base station 405. The wireless device 415 may transmit a first reference signal to the base station 405 and upon detecting the first reference signal, the base station 405 may transmit a second reference signal to the wireless device 415. If the wireless device 415 does detect the second reference signal from the base station 405, then remote interference is assumed and the wireless device 415 may validate or verify the machine learning model. If the wireless device 415 does not detect the second reference signal from the base station 405, remote interference may not be assumed and the machine learning model may not be verified and this information is used to train or improve the machine learning model.

At 435, the wireless device 415 may predict that interference is present based at least in part on the output of the machine learning model. Upon predicting the presence of remote interference, the wireless device 415 may perform an interference mitigation procedure at 440. That is, the wireless device may transmit a first reference signal to the base station 405. The base station 405 may detect the first reference signal and apply interference mitigation schemes as described in FIG. 2 and transmit a second reference signal to the wireless device 415 according to the interference mitigation schemes. If the wireless device 415 does not detect the second reference signal, the remote interference mitigation procedure may be deemed a success and the wireless device 415 may refrain from transmitting another first reference signal. If the wireless device 415 does detect the second reference signal, the wireless device 415 and the base station 405 may repeatedly exchange reference signals until the wireless device 415 does not detect the second reference signal from the base station 405.

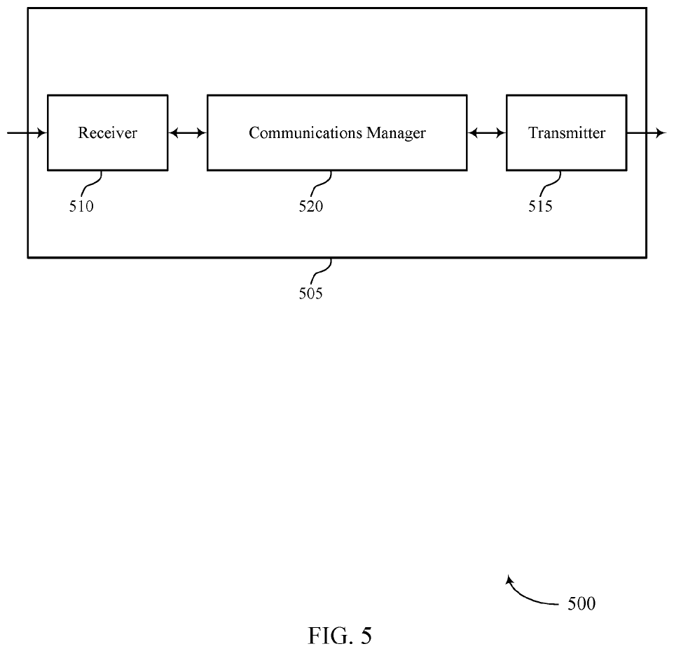

FIG. 5 shows a block diagram 500 of a device 505 that supports remote interference detection based on machine learning in accordance with aspects of the present disclosure. The device 505 may be an example of aspects of a UE 115 or a base station 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to remote interference detection based on machine learning). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to remote interference detection based on machine learning). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of remote interference detection based on machine learning as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a first wireless device in accordance with examples as disclosed herein. For example, the communications manager 520 may be configured as or otherwise support a means for receiving, at the first wireless device from a network node, a machine learning model for use by the first wireless device to detect remote interference from a base station, where the first wireless device is associated with a first cell and the base station is associated with a second cell different from the first cell. The communications manager 520 may be configured as or otherwise support a means for inputting, by the first wireless device, one or more parameters into the machine learning model. The communications manager 520 may be configured as or otherwise support a means for detecting, by the first wireless device, whether the remote interference from the base station is present based on an output of the machine learning model, the output based on the one or more parameters input into the machine learning model.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced power consumption and more efficient utilization of communication resources. The methods as described herein may allow the device 505 to more accurately detect remote interference when compared to other remote interference detection techniques (e.g., manually detecting remote interference). Providing better accuracy in remote interference detection may allow the device 505 to avoid performing a remote interference procedure that would have been overwise performed using traditional detection methods which may enable power savings at the device 505.

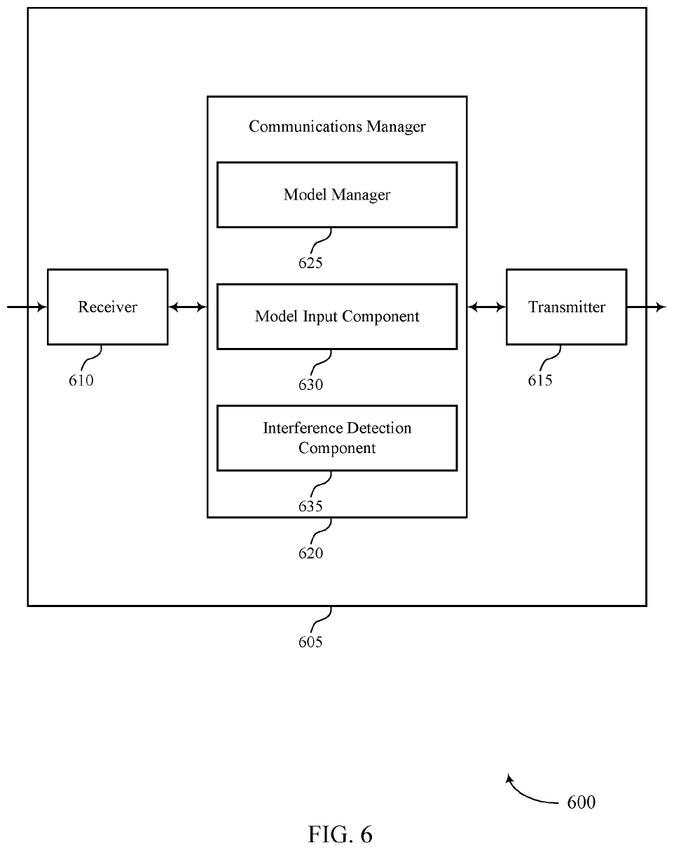

FIG. 6 shows a block diagram 600 of a device 605 that supports remote interference detection based on machine learning in accordance with aspects of the present disclosure. The device 605 may be an example of aspects of a device 505, a UE 115, or a base station 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to remote interference detection based on machine learning). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to remote interference detection based on machine learning). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of remote interference detection based on machine learning as described herein. For example, the communications manager 620 may include a model manager 625, a model input component 630, an interference detection component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first wireless device in accordance with examples as disclosed herein. The model manager 625 may be configured as or otherwise support a means for receiving, at the first wireless device from a network node, a machine learning model for use by the first wireless device to detect remote interference from a base station, where the first wireless device is associated with a first cell and the base station is associated with a second cell different from the first cell. The model input component 630 may be configured as or otherwise support a means for inputting, by the first wireless device, one or more parameters into the machine learning model. The interference detection component 635 may be configured as or otherwise support a means for detecting, by the first wireless device, whether the remote interference from the base station is present based on an output of the machine learning model, the output based on the one or more parameters input into the machine learning model.

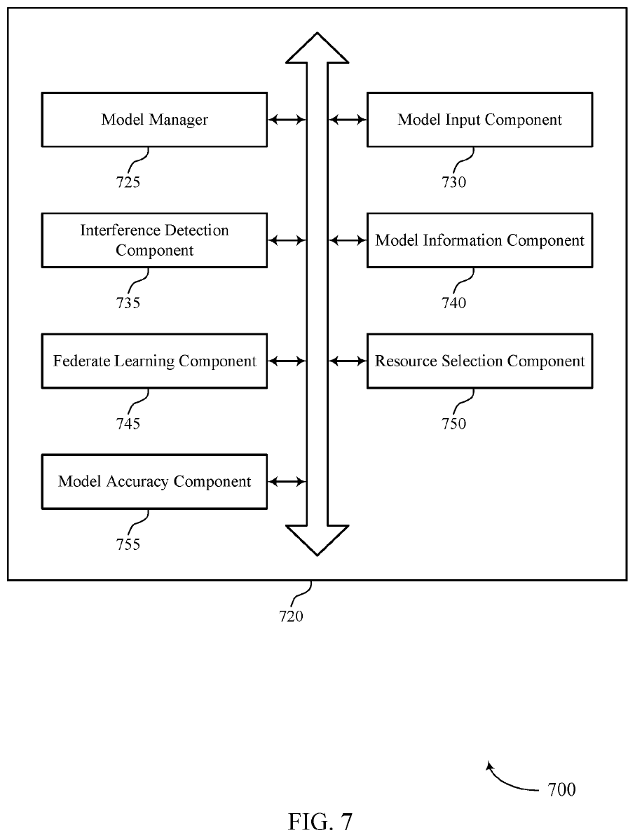

FIG. 7 shows a block diagram 700 of a communications manager 720 that supports remote interference detection based on machine learning in accordance with aspects of the present disclosure. The communications manager 720 may be an example of aspects of a communications manager 520, a communications manager 620, or both, as described herein. The communications manager 720, or various components thereof, may be an example of means for performing various aspects of remote interference detection based on machine learning as described herein. For example, the communications manager 720 may include a model manager 725, a model input component 730, an interference detection component 735, a model information component 740, a federate learning component 745, a resource selection component 750, a model accuracy component 755, or any combination thereof. Each of these components may communicate, directly or indirectly, with one another (e.g., via one or more buses).

The communications manager 720 may support wireless communication at a first wireless device in accordance with examples as disclosed herein. The model manager 725 may be configured as or otherwise support a means for receiving, at the first wireless device from a network node, a machine learning model for use by the first wireless device to detect remote interference from a base station, where the first wireless device is associated with a first cell and the base station is associated with a second cell different from the first cell. The model input component 730 may be configured as or otherwise support a means for inputting, by the first wireless device, one or more parameters into the machine learning model. The interference detection component 735 may be configured as or otherwise support a means for detecting, by the first wireless device, whether the remote interference from the base station is present based on an output of the machine learning model, the output based on the one or more parameters input into the machine learning model.

In some examples, the model information component 740 may be configured as or otherwise support a means for transmitting, to the network node and after detecting whether the remote interference from the base station is present, one or more indications that indicate the one or more parameters input into the machine learning model, the output of the machine learning model, or any combination thereof.

In some examples, the model accuracy component 755 may be configured as or otherwise support a means for receiving, after detecting whether the remote interference from the base station is present, a reference signal from the base station based on transmitting the one or more indications. In some examples, the model accuracy component 755 may be configured as or otherwise support a means for determining whether the output of the machine learning model is accurate based on the reference signal.

In some examples, the model accuracy component 755 may be configured as or otherwise support a means for transmitting, to the network node after determining whether the output of the machine learning model is accurate, an indication of whether the output of the machine learning model is accurate.

In some examples, the federate learning component 745 may be configured as or otherwise support a means for receiving, from the network node, an updated version of the machine learning model, the updated version of the machine learning model based on the one or more parameters input into the machine learning model, the output of the machine learning model, one or more second parameters input into respective machine learning models implemented at one or more second wireless devices, one or more respective second outputs of the respective machine learning models obtained by the one or more second wireless devices, or any combination thereof.

In some examples, the resource selection component 750 may be configured as or otherwise support a means for selecting a time resource, a frequency resource, or both for an uplink transmission based on detecting whether the remote interference from the base station is present.

In some examples, the one or more parameters may include an energy waveform parameter for a signal received at the first wireless device over a duration, a date, a time, an uplink reception rate in one or more uplink symbols, a location of the first wireless device, a weather condition, a frequency resource or a time resource corresponding to a failed uplink transmission, or any combination thereof.

In some examples, the one or more parameters may include the energy waveform parameter for the signal. In some examples, the duration may include one or more symbols between a first time period for downlink signaling within the first cell and a next time period for downlink signaling within the first cell.

In some examples, the one or more parameters may include the energy waveform parameter for the signal, the energy waveform parameter including a slope of received power for the signal, an initial received power for the signal, or both.

In some examples, the output of the machine learning model may include an indication of whether the remote interference from the base station is present, one or more IDs associated with one or more base stations causing remote interference, a distance between the first wireless device and the base station, a direction of the remote interference from the base station, a quantity of the one or more base stations causing remote interference, or any combination thereof.

In some examples, the first wireless device may include a base station that provides service within the first cell or a UE communicating within the first cell.

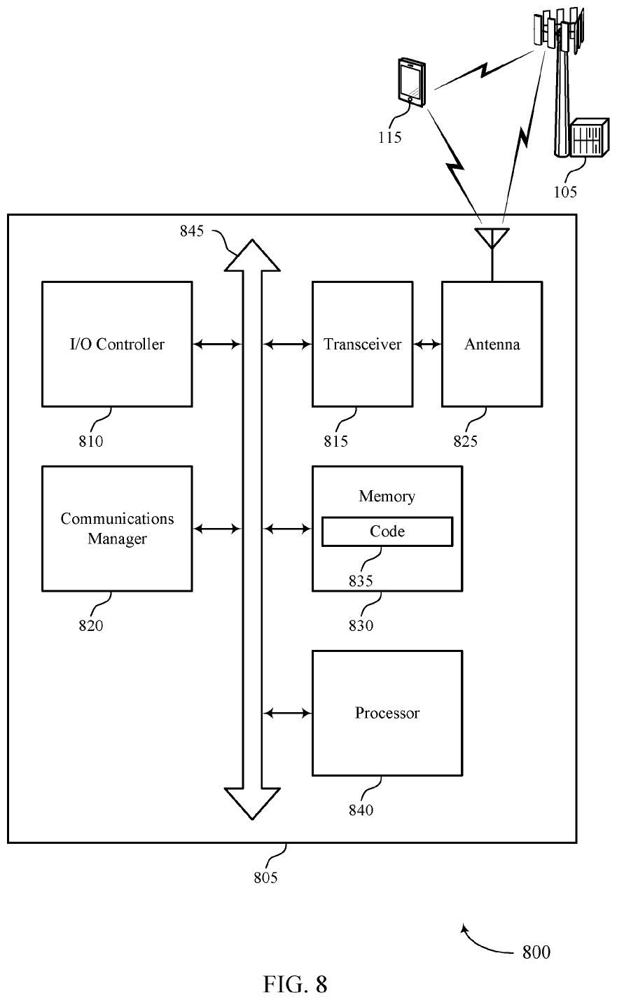

FIG. 8 shows a diagram of a system 800 including a device 805 that supports remote interference detection based on machine learning in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting remote interference detection based on machine learning). For example, the device 805 or a component of the device 805 may include a processor 840 and memory 830 coupled to the processor 840, the processor 840 and memory 830 configured to perform various functions described herein.

The communications manager 820 may support wireless communication at a first wireless device in accordance with examples as disclosed herein. For example, the communications manager 820 may be configured as or otherwise support a means for receiving, at the first wireless device from a network node, a machine learning model for use by the first wireless device to detect remote interference from a base station, where the first wireless device is associated with a first cell and the base station is associated with a second cell different from the first cell. The communications manager 820 may be configured as or otherwise support a means for inputting, by the first wireless device, one or more parameters into the machine learning model. The communications manager 820 may be configured as or otherwise support a means for detecting, by the first wireless device, whether the remote interference from the base station is present based on an output of the machine learning model, the output based on the one or more parameters input into the machine learning model.

By including or configuring the communications manager 820 in accordance with examples as described herein, the device 805 may support techniques for reduced latency, reduced power consumption, and more efficient utilization of communication resources. As opposed to other methods, the techniques as described herein do not require an operator to manually detect remote interference at the device 805. As such, latency related to the manually detection of remote interference may be avoided.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of remote interference detection based on machine learning as described herein, or the processor 840 and the memory 830 may be otherwise configured to perform or support such operations.

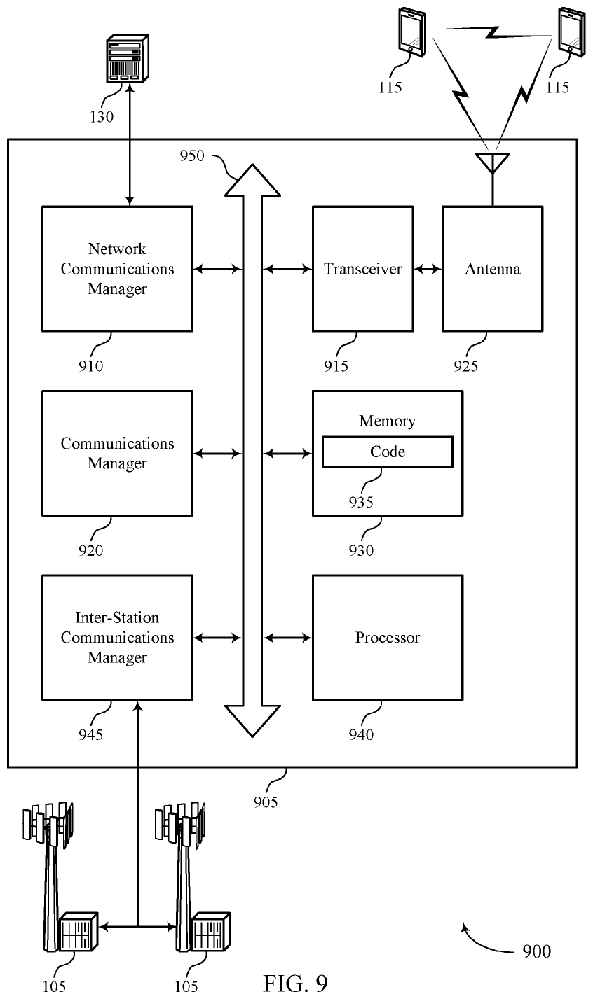

FIG. 9 shows a diagram of a system 900 including a device 905 that supports remote interference detection based on machine learning in accordance with aspects of the present disclosure. The device 905 may be an example of or include the components of a device 505, a device 605, or a base station 105 as described herein. The device 905 may communicate wirelessly with one or more base stations 105, UEs 115, or any combination thereof. The device 905 may include components for bi-directional voice and data communications including components for transmitting and receiving communications, such as a communications manager 920, a network communications manager 910, a transceiver 915, an antenna 925, a memory 930, code 935, a processor 940, and an inter-station communications manager 945. These components may be in electronic communication or otherwise coupled (e.g., operatively, communicatively, functionally, electronically, electrically) via one or more buses (e.g., a bus 950).

The network communications manager 910 may manage communications with a core network 130 (e.g., via one or more wired backhaul links). For example, the network communications manager 910 may manage the transfer of data communications for client devices, such as one or more UEs 115.

In some cases, the device 905 may include a single antenna 925. However, in some other cases the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 515, a transmitter 615, a receiver 510, a receiver 610, or any combination thereof or component thereof, as described herein.

The memory 930 may include RAM and ROM. The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a BIOS which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting remote interference detection based on machine learning). For example, the device 905 or a component of the device 905 may include a processor 940 and memory 930 coupled to the processor 940, the processor 940 and memory 930 configured to perform various functions described herein.

The inter-station communications manager 945 may manage communications with other base stations 105, and may include a controller or scheduler for controlling communications with UEs 115 in cooperation with other base stations 105. For example, the inter-station communications manager 945 may coordinate scheduling for transmissions to UEs 115 for various interference mitigation techniques such as beamforming or joint transmission. In some examples, the inter-station communications manager 945 may provide an X2 interface within an LTE/LTE-A wireless communications network technology to provide communication between base stations 105.

The communications manager 920 may support wireless communication at a first wireless device in accordance with examples as disclosed herein. For example, the communications manager 920 may be configured as or otherwise support a means for receiving, at the first wireless device from a network node, a machine learning model for use by the first wireless device to detect remote interference from a base station, where the first wireless device is associated with a first cell and the base station is associated with a second cell different from the first cell. The communications manager 920 may be configured as or otherwise support a means for inputting, by the first wireless device, one or more parameters into the machine learning model. The communications manager 920 may be configured as or otherwise support a means for detecting, by the first wireless device, whether the remote interference from the base station is present based on an output of the machine learning model, the output based on the one or more parameters input into the machine learning model.

By including or configuring the communications manager 920 in accordance with examples as described herein, the device 905 may support techniques reduced latency, reduced power consumption, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of remote interference detection based on machine learning as described herein, or the processor 940 and the memory 930 may be otherwise configured to perform or support such operations.

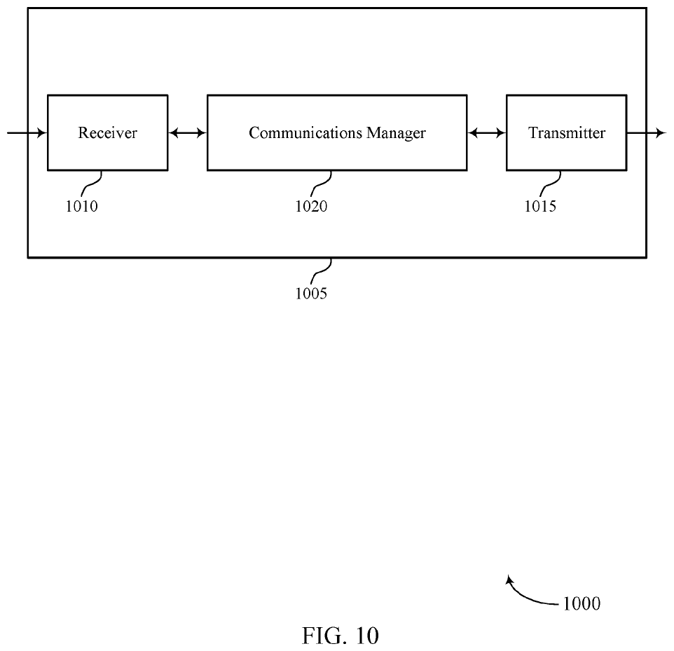

FIG. 10 shows a block diagram 1000 of a device 1005 that supports remote interference detection based on machine learning in accordance with aspects of the present disclosure. The device 1005 may be an example of aspects of a network entity (e.g., a network node 350) as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to remote interference detection based on machine learning). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to remote interference detection based on machine learning). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of remote interference detection based on machine learning as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

For example, the communications manager 1020 may be configured as or otherwise support a means for transmitting, to a first wireless device, a machine learning model for the first wireless device to detect remote interference from a base station, where the first wireless device is associated with a first cell and the base station is associated with a second cell different from the first cell. The communications manager 1020 may be configured as or otherwise support a means for receiving, from the first wireless device, signaling that indicates one or more parameters input into the machine learning model by the first wireless device, an output of the machine learning model obtained by the first wireless device, or any combination thereof. The communications manager 1020 may be configured as or otherwise support a means for determining an updated version of the machine learning model based on the one or more parameters input into the machine learning model by the first wireless device, the output of the machine learning model obtained by the first wireless device, or any combination thereof.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for more efficient utilization of communication resources.

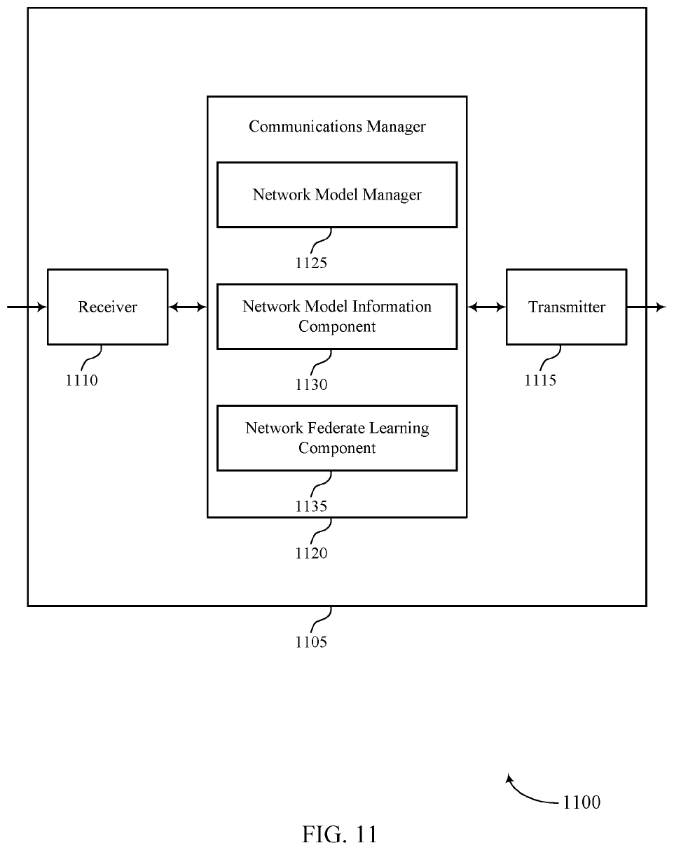

FIG. 11 shows a block diagram 1100 of a device 1105 that supports remote interference detection based on machine learning in accordance with aspects of the present disclosure. The device 1105 may be an example of aspects of a device 1005 or a network entity as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to remote interference detection based on machine learning). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to remote interference detection based on machine learning). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of remote interference detection based on machine learning as described herein. For example, the communications manager 1120 may include a network model manager 1125, a network model information component 1130, a network federate learning component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The network model manager 1125 may be configured as or otherwise support a means for transmitting, to a first wireless device, a machine learning model for the first wireless device to detect remote interference from a base station, where the first wireless device is associated with a first cell and the base station is associated with a second cell different from the first cell. The network model information component 1130 may be configured as or otherwise support a means for receiving, from the first wireless device, signaling that indicates one or more parameters input into the machine learning model by the first wireless device, an output of the machine learning model obtained by the first wireless device, or any combination thereof. The network federate learning component 1135 may be configured as or otherwise support a means for determining an updated version of the machine learning model based on the one or more parameters input into the machine learning model by the first wireless device, the output of the machine learning model obtained by the first wireless device, or any combination thereof.

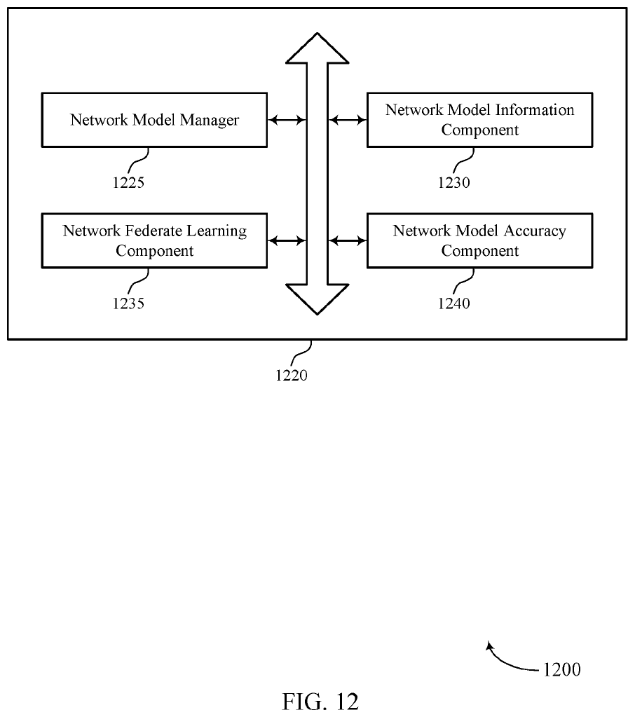

FIG. 12 shows a block diagram 1200 of a communications manager 1220 that supports remote interference detection based on machine learning in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of remote interference detection based on machine learning as described herein. For example, the communications manager 1220 may include a network model manager 1225, a network model information component 1230, a network federate learning component 1235, a network model accuracy component 1240, or any combination thereof. Each of these components may communicate, directly or indirectly, with one another (e.g., via one or more buses).

The network model manager 1225 may be configured as or otherwise support a means for transmitting, to a first wireless device, a machine learning model for the first wireless device to detect remote interference from a base station, where the first wireless device is associated with a first cell and the base station is associated with a second cell different from the first cell. The network model information component 1230 may be configured as or otherwise support a means for receiving, from the first wireless device, signaling that indicates one or more parameters input into the machine learning model by the first wireless device, an output of the machine learning model obtained by the first wireless device, or any combination thereof. The network federate learning component 1235 may be configured as or otherwise support a means for determining an updated version of the machine learning model based on the one or more parameters input into the machine learning model by the first wireless device, the output of the machine learning model obtained by the first wireless device, or any combination thereof.

In some examples, the network model accuracy component 1240 may be configured as or otherwise support a means for transmitting, to the base station and after receiving the signaling that indicates the one or more parameters input into the machine learning model, the output of the machine learning model, or any combination thereof, signaling that instructs the base station to transmit a reference signal to the first wireless device to evaluate whether the output of the machine learning model is accurate.

In some examples, the network federate learning component 1235 may be configured as or otherwise support a means for transmitting the updated version of the machine learning model to the first wireless device.

In some examples, the network model information component 1230 may be configured as or otherwise support a means for receiving, from one or more second wireless devices, signaling that indicates one or more second parameters input into respective machine learning models implemented at the one or more second wireless devices, one or more respective outputs of the respective machine learning models obtained by the one or more second wireless devices, or any combination thereof.

In some examples, determining the updated version of the machine learning model is further based on the one or more second parameters input into respective machine learning models implemented at the one or more second wireless devices, the one or more respective second outputs of the respective machine learning models obtained by the one or more second wireless devices, or any combination thereof.

In some examples, a first portion of the machine learning model may be for a set of wireless devices that includes the first wireless device, the one or more second wireless devices, and one or more additional wireless devices and a second portion of the machine learning model may be for a subset of the set of wireless devices, the subset including the first wireless device and the one or more second wireless devices.

In some examples, the output of the machine learning model may be obtained by the first wireless device and the one or more respective second outputs of the respective machine learning models obtained by the one or more second wireless devices are each associated with the first portion of the machine learning model and each include an ID associated with the base station.

In some examples, the network model information component 1230 may be configured as or otherwise support a means for receiving, from the one or more additional wireless devices, signaling that indicates one or more third parameters input into respective machine learning models implemented at the one or more additional wireless devices, one or more respective third outputs of the respective machine learning models obtained by the one or more additional wireless devices, or any combination thereof. In some examples, to determine the updated version of the machine learning model, the network federate learning component 1235 may be configured as or otherwise support a means for determining an updated version of the first portion of the machine learning model based on the one or more third parameters input into the respective machine learning models implemented at the one or more additional wireless devices, the one or more respective third outputs of the respective machine learning models obtained by the one or more additional wireless devices, or any combination thereof and the network federate learning component 1235 may be configured as or otherwise support a means for determining an updated version of the second portion of the machine learning model independent of the one or more third parameters input into respective machine learning models implemented at the one or more additional wireless devices, the one or more respective third outputs of the respective machine learning models obtained by the one or more additional wireless devices, or any combination thereof. In some examples, the network federate learning component 1235 may be configured as or otherwise support a means for transmitting the updated version of the first portion of the machine learning model to each wireless device of the set of wireless devices. In some examples, the network federate learning component 1235 may be configured as or otherwise support a means for transmitting the updated version of the second portion of the machine learning model to each wireless device of the subset of the set of wireless devices.

In some examples, the one or more parameters may include an energy waveform parameter for a signal received at the first wireless device over a duration, a date, a time, an uplink reception rate in one or more uplink symbols, a location of the first wireless device, a weather condition, a frequency resource or a time resource corresponding to a failed uplink transmission, or any combination thereof.

In some examples, the output of the machine learning model may include an indication of whether the remote interference from the base station is present, one or more IDs associated with one or more base stations causing remote interference, a distance between the first wireless device and the base station, a direction of the remote interference from the base station, a quantity of the one or more base stations causing remote interference, or any combination thereof.

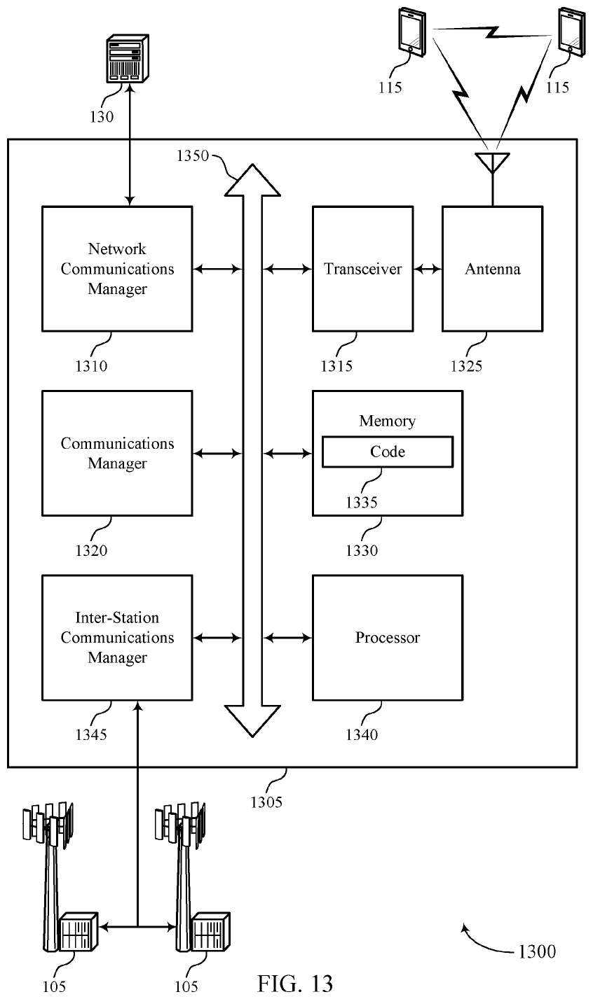

FIG. 13 shows a diagram of a system 1300 including a device 1305 that supports remote interference detection based on machine learning in accordance with aspects of the present disclosure. The device 1305 may be an example of or include the components of a device 1005, a device 1105, or a network entity as described herein. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting remote interference detection based on machine learning). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

For example, the communications manager 1320 may be configured as or otherwise support a means for transmitting, to a first wireless device, a machine learning model for the first wireless device to detect remote interference from a base station, where the first wireless device is associated with a first cell and the base station is associated with a second cell different from the first cell. The communications manager 1320 may be configured as or otherwise support a means for receiving, from the first wireless device, signaling that indicates one or more parameters input into the machine learning model by the first wireless device, an output of the machine learning model obtained by the first wireless device, or any combination thereof. The communications manager 1320 may be configured as or otherwise support a means for determining an updated version of the machine learning model based on the one or more parameters input into the machine learning model by the first wireless device, the output of the machine learning model obtained by the first wireless device, or any combination thereof.

By including or configuring the communications manager 1320 in accordance with examples as described herein, the device 1305 may support techniques for reduced latency and more efficient utilization of communication resources.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of remote interference detection based on machine learning as described herein, or the processor 1340 and the memory 1330 may be otherwise configured to perform or support such operations.

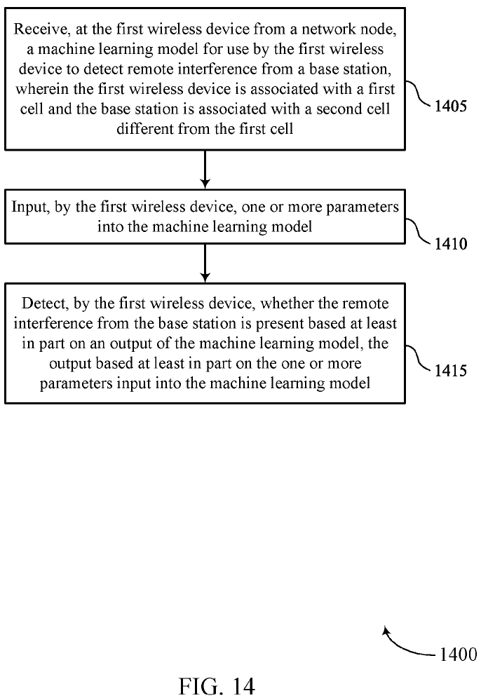

FIG. 14 shows a flowchart illustrating a method 1400 that supports remote interference detection based on machine learning in accordance with aspects of the present disclosure. The operations of the method 1400 may be implemented by a UE or a base station or its components as described herein. For example, the operations of the method 1400 may be performed by a UE 115 or a base station 105 as described with reference to FIGS. 1 through 9. In some examples, a UE or a base station may execute a set of instructions to control the functional elements of the UE or the base station to perform the described functions. Additionally or alternatively, the UE or the base station may perform aspects of the described functions using special-purpose hardware.

At 1405, the method may include receiving, at the first wireless device from a network node, a machine learning model for use by the first wireless device to detect remote interference from a base station, where the first wireless device is associated with a first cell and the base station is associated with a second cell different from the first cell. The operations of 1405 may be performed in accordance with examples as disclosed herein. In some examples, aspects of the operations of 1405 may be performed by a model manager 725 as described with reference to FIG. 7.

At 1410, the method may include inputting, by the first wireless device, one or more parameters into the machine learning model. The operations of 1410 may be performed in accordance with examples as disclosed herein. In some examples, aspects of the operations of 1410 may be performed by a model input component 730 as described with reference to FIG. 7.

At 1415, the method may include detecting, by the first wireless device, whether the remote interference from the base station is present based on an output of the machine learning model, the output based on the one or more parameters input into the machine learning model. The operations of 1415 may be performed in accordance with examples as disclosed herein. In some examples, aspects of the operations of 1415 may be performed by an interference detection component 735 as described with reference to FIG. 7.

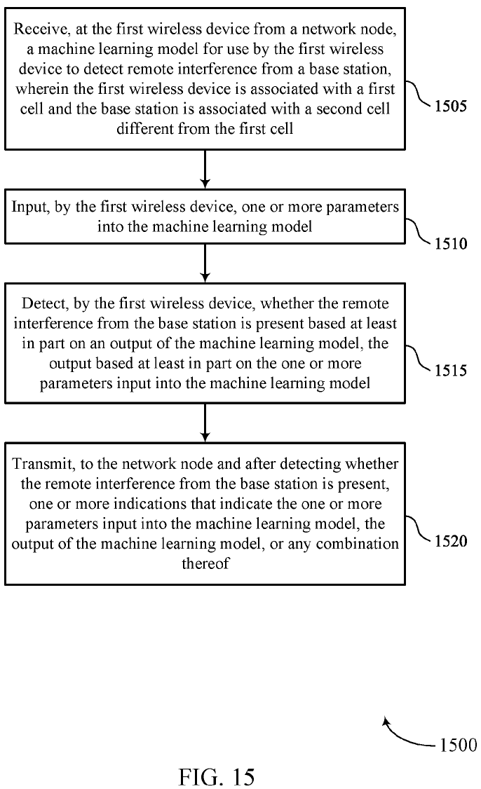

FIG. 15 shows a flowchart illustrating a method 1500 that supports remote interference detection based on machine learning in accordance with aspects of the present disclosure. The operations of the method 1500 may be implemented by a UE or a base station or its components as described herein. For example, the operations of the method 1500 may be performed by a UE 115 or a base station 105 as described with reference to FIGS. 1 through 9. In some examples, a UE or a base station may execute a set of instructions to control the functional elements of the UE or the base station to perform the described functions. Additionally or alternatively, the UE or the base station may perform aspects of the described functions using special-purpose hardware.

At 1505, the method may include receiving, at the first wireless device from a network node, a machine learning model for use by the first wireless device to detect remote interference from a base station, where the first wireless device is associated with a first cell and the base station is associated with a second cell different from the first cell. The operations of 1505 may be performed in accordance with examples as disclosed herein. In some examples, aspects of the operations of 1505 may be performed by a model manager 725 as described with reference to FIG. 7.

At 1510, the method may include inputting, by the first wireless device, one or more parameters into the machine learning model. The operations of 1510 may be performed in accordance with examples as disclosed herein. In some examples, aspects of the operations of 1510 may be performed by a model input component 730 as described with reference to FIG. 7.

At 1515, the method may include detecting, by the first wireless device, whether the remote interference from the base station is present based on an output of the machine learning model, the output based on the one or more parameters input into the machine learning model. The operations of 1515 may be performed in accordance with examples as disclosed herein. In some examples, aspects of the operations of 1515 may be performed by an interference detection component 735 as described with reference to FIG. 7.

At 1520, the method may include transmitting, to the network node and after detecting whether the remote interference from the base station is present, one or more indications that indicate the one or more parameters input into the machine learning model, the output of the machine learning model, or any combination thereof. The operations of 1520 may be performed in accordance with examples as disclosed herein. In some examples, aspects of the operations of 1520 may be performed by a model information component 740 as described with reference to FIG. 7.

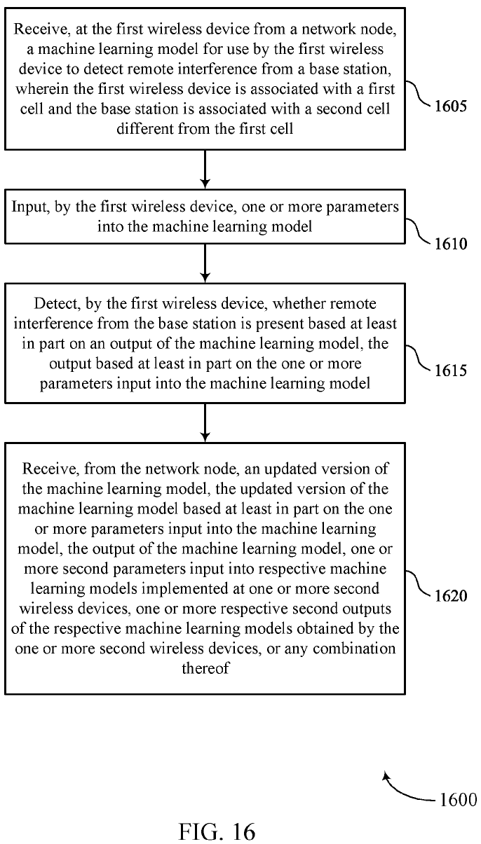

FIG. 16 shows a flowchart illustrating a method 1600 that supports remote interference detection based on machine learning in accordance with aspects of the present disclosure. The operations of the method 1600 may be implemented by a UE or a base station or its components as described herein. For example, the operations of the method 1600 may be performed by a UE 115 or a base station 105 as described with reference to FIGS. 1 through 9. In some examples, a UE or a base station may execute a set of instructions to control the functional elements of the UE or the base station to perform the described functions. Additionally or alternatively, the UE or the base station may perform aspects of the described functions using special-purpose hardware.

At 1605, the method may include receiving, at the first wireless device from a network node, a machine learning model for use by the first wireless device to detect remote interference from a base station, where the first wireless device is associated with a first cell and the base station is associated with a second cell different from the first cell. The operations of 1605 may be performed in accordance with examples as disclosed herein. In some examples, aspects of the operations of 1605 may be performed by a model manager 725 as described with reference to FIG. 7.

At 1610, the method may include inputting, by the first wireless device, one or more parameters into the machine learning model. The operations of 1610 may be performed in accordance with examples as disclosed herein. In some examples, aspects of the operations of 1610 may be performed by a model input component 730 as described with reference to FIG. 7.

At 1615, the method may include detecting, by the first wireless device, whether the remote interference from the base station is present based on an output of the machine learning model, the output based on the one or more parameters input into the machine learning model. The operations of 1615 may be performed in accordance with examples as disclosed herein. In some examples, aspects of the operations of 1615 may be performed by an interference detection component 735 as described with reference to FIG. 7.

At 1620, the method may include receiving, from the network node, an updated version of the machine learning model, the updated version of the machine learning model based on the one or more parameters input into the machine learning model, the output of the machine learning model, one or more second parameters input into respective machine learning models implemented at one or more second wireless devices, one or more respective second outputs of the respective machine learning models obtained by the one or more second wireless devices, or any combination thereof. The operations of 1620 may be performed in accordance with examples as disclosed herein. In some examples, aspects of the operations of 1620 may be performed by a federate learning component 745 as described with reference to FIG. 7.

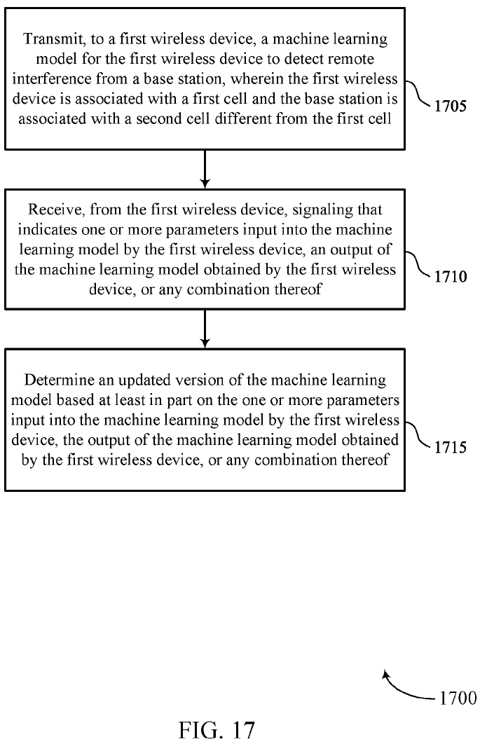

FIG. 17 shows a flowchart illustrating a method 1700 that supports remote interference detection based on machine learning in accordance with aspects of the present disclosure. The operations of the method 1700 may be implemented by a network entity or its components as described herein. For example, the operations of the method 1700 may be performed by a network entity as described with reference to FIGS. 1 through 4 and 10 through 13. In some examples, a network entity may execute a set of instructions to control the functional elements of the network entity to perform the described functions. Additionally or alternatively, the network entity may perform aspects of the described functions using special-purpose hardware.

At 1705, the method may include transmitting, to a first wireless device, a machine learning model for the first wireless device to detect remote interference from a base station, where the first wireless device is associated with a first cell and the base station is associated with a second cell different from the first cell. The operations of 1705 may be performed in accordance with examples as disclosed herein. In some examples, aspects of the operations of 1705 may be performed by a network model manager 1225 as described with reference to FIG. 12.

At 1710, the method may include receiving, from the first wireless device, signaling that indicates one or more parameters input into the machine learning model by the first wireless device, an output of the machine learning model obtained by the first wireless device, or any combination thereof. The operations of 1710 may be performed in accordance with examples as disclosed herein. In some examples, aspects of the operations of 1710 may be performed by a network model information component 1230 as described with reference to FIG. 12.

At 1715, the method may include determining an updated version of the machine learning model based on the one or more parameters input into the machine learning model by the first wireless device, the output of the machine learning model obtained by the first wireless device, or any combination thereof. The operations of 1715 may be performed in accordance with examples as disclosed herein. In some examples, aspects of the operations of 1715 may be performed by a network federate learning component 1235 as described with reference to FIG. 12.

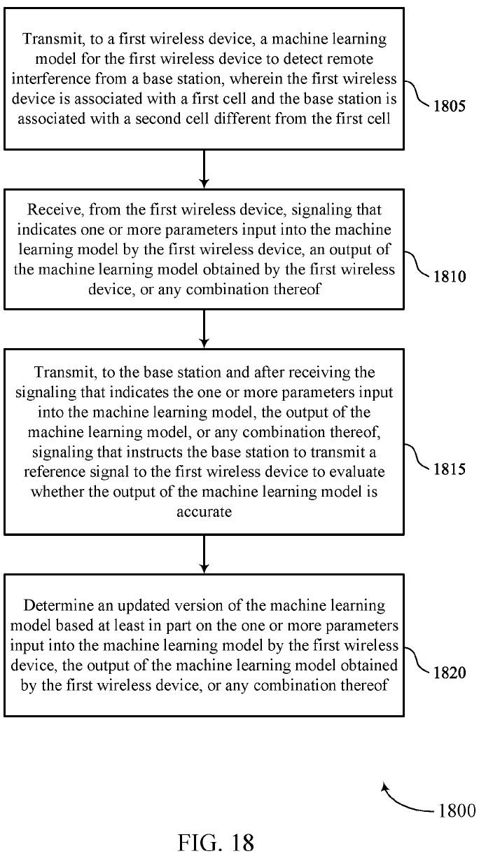

FIG. 18 shows a flowchart illustrating a method 1800 that supports remote interference detection based on machine learning in accordance with aspects of the present disclosure. The operations of the method 1800 may be implemented by a network entity or its components as described herein. For example, the operations of the method 1800 may be performed by a network entity as described with reference to FIGS. 1 through 4 and 10 through 13. In some examples, a network entity may execute a set of instructions to control the functional elements of the network entity to perform the described functions. Additionally or alternatively, the network entity may perform aspects of the described functions using special-purpose hardware.

At 1805, the method may include transmitting, to a first wireless device, a machine learning model for the first wireless device to detect remote interference from a base station, where the first wireless device is associated with a first cell and the base station is associated with a second cell different from the first cell. The operations of 1805 may be performed in accordance with examples as disclosed herein. In some examples, aspects of the operations of 1805 may be performed by a network model manager 1225 as described with reference to FIG. 12.

At 1810, the method may include receiving, from the first wireless device, signaling that indicates one or more parameters input into the machine learning model by the first wireless device, an output of the machine learning model obtained by the first wireless device, or any combination thereof. The operations of 1810 may be performed in accordance with examples as disclosed herein. In some examples, aspects of the operations of 1810 may be performed by a network model information component 1230 as described with reference to FIG. 12.

At 1815, the method may include transmitting, to the base station and after receiving the signaling that indicates the one or more parameters input into the machine learning model, the output of the machine learning model, or any combination thereof, signaling that instructs the base station to transmit a reference signal to the first wireless device to evaluate whether the output of the machine learning model is accurate. The operations of 1815 may be performed in accordance with examples as disclosed herein. In some examples, aspects of the operations of 1815 may be performed by a network model accuracy component 1240 as described with reference to FIG. 12.

At 1820, the method may include determining an updated version of the machine learning model based on the one or more parameters input into the machine learning model by the first wireless device, the output of the machine learning model obtained by the first wireless device, or any combination thereof. The operations of 1820 may be performed in accordance with examples as disclosed herein. In some examples, aspects of the operations of 1820 may be performed by a network federate learning component 1235 as described with reference to FIG. 12.

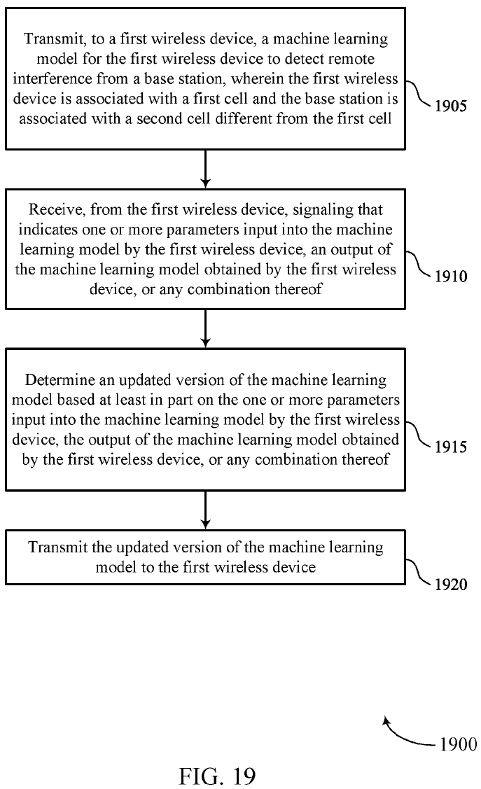

FIG. 19 shows a flowchart illustrating a method 1900 that supports remote interference detection based on machine learning in accordance with aspects of the present disclosure. The operations of the method 1900 may be implemented by a network entity or its components as described herein. For example, the operations of the method 1900 may be performed by a network entity as described with reference to FIGS. 1 through 4 and 10 through 13. In some examples, a network entity may execute a set of instructions to control the functional elements of the network entity to perform the described functions. Additionally or alternatively, the network entity may perform aspects of the described functions using special-purpose hardware.

At 1905, the method may include transmitting, to a first wireless device, a machine learning model for the first wireless device to detect remote interference from a base station, where the first wireless device is associated with a first cell and the base station is associated with a second cell different from the first cell. The operations of 1905 may be performed in accordance with examples as disclosed herein. In some examples, aspects of the operations of 1905 may be performed by a network model manager 1225 as described with reference to FIG. 12.

At 1910, the method may include receiving, from the first wireless device, signaling that indicates one or more parameters input into the machine learning model by the first wireless device, an output of the machine learning model obtained by the first wireless device, or any combination thereof. The operations of 1910 may be performed in accordance with examples as disclosed herein. In some examples, aspects of the operations of 1910 may be performed by a network model information component 1230 as described with reference to FIG. 12.

At 1915, the method may include determining an updated version of the machine learning model based on the one or more parameters input into the machine learning model by the first wireless device, the output of the machine learning model obtained by the first wireless device, or any combination thereof. The operations of 1915 may be performed in accordance with examples as disclosed herein. In some examples, aspects of the operations of 1915 may be performed by a network federate learning component 1235 as described with reference to FIG. 12.

At 1920, the method may include transmitting the updated version of the machine learning model to the first wireless device. The operations of 1920 may be performed in accordance with examples as disclosed herein. In some examples, aspects of the operations of 1920 may be performed by a network federate learning component 1235 as described with reference to FIG. 12.

The following provides an overview of aspects of the present disclosure:

Aspect 1: A method for wireless communication at a first wireless device, comprising: receiving, at the first wireless device from a network node, a machine learning model for use by the first wireless device to detect remote interference from a base station, wherein the first wireless device is associated with a first cell and the base station is associated with a second cell different from the first cell; inputting, by the first wireless device, one or more parameters into the machine learning model; and detecting, by the first wireless device, whether the remote interference from the base station is present based at least in part on an output of the machine learning model, the output based at least in part on the one or more parameters input into the machine learning model.

Aspect 2: The method of aspect 1, further comprising: transmitting, to the network node and after detecting whether the remote interference from the base station is present, one or more indications that indicate the one or more parameters input into the machine learning model, the output of the machine learning model, or any combination thereof.

Aspect 3: The method of aspect 2, further comprising: receiving, after detecting whether the remote interference from the base station is present, a reference signal from the base station based at least in part on transmitting the one or more indications; and determining whether the output of the machine learning model is accurate based at least in part on the reference signal.

Aspect 4: The method of aspect 3, further comprising: transmitting, to the network node after determining whether the output of the machine learning model is accurate, an indication of whether the output of the machine learning model is accurate.

Aspect 5: The method of any of aspects 1 through 4, further comprising: receiving, from the network node, an updated version of the machine learning model, the updated version of the machine learning model based at least in part on the one or more parameters input into the machine learning model, the output of the machine learning model, one or more second parameters input into respective machine learning models implemented at one or more second wireless devices, one or more respective second outputs of the respective machine learning models obtained by the one or more second wireless devices, or any combination thereof.

Aspect 6: The method of any of aspects 1 through 5, further comprising: selecting a time resource, a frequency resource, or both for an uplink transmission based at least in part on detecting whether the remote interference from the base station is present.

Aspect 7: The method of any of aspects 1 through 6, wherein the one or more parameters comprise an energy waveform parameter for a signal received at the first wireless device over a duration, a date, a time, an uplink reception rate in one or more uplink symbols, a location of the first wireless device, a weather condition, a frequency resource or a time resource corresponding to a failed uplink transmission, or any combination thereof.

Aspect 8: The method of aspect 7, wherein the one or more parameters comprises the energy waveform parameter for the signal, and the duration comprises one or more symbols between a first time period for downlink signaling within the first cell and a next time period for downlink signaling within the first cell.

Aspect 9: The method of any of aspects 7 through 8, wherein the one or more parameters comprises the energy waveform parameter for the signal, the energy waveform parameter comprising a slope of received power for the signal, an initial received power for the signal, or both.

Aspect 10: The method of any of aspects 1 through 9, wherein the output of the machine learning model comprises an indication of whether the remote interference from the base station is present, one or more identifiers associated with one or more base stations causing remote interference, a distance between the first wireless device and the base station, a direction of the remote interference from the base station, a quantity of the one or more base stations causing remote interference, or any combination thereof.

Aspect 11: The method of any of aspects 1 through 10, wherein the first wireless device comprises a base station that provides service within the first cell or a UE communicating within the first cell.

Aspect 12: A method at a network node, the method comprising: transmitting, to a first wireless device, a machine learning model for the first wireless device to detect remote interference from a base station, wherein the first wireless device is associated with a first cell and the base station is associated with a second cell different from the first cell; receiving, from the first wireless device, signaling that indicates one or more parameters input into the machine learning model by the first wireless device, an output of the machine learning model obtained by the first wireless device, or any combination thereof; and determining an updated version of the machine learning model based at least in part on the one or more parameters input into the machine learning model by the first wireless device, the output of the machine learning model obtained by the first wireless device, or any combination thereof.

Aspect 13: The method of aspect 12, further comprising: transmitting, to the base station and after receiving the signaling that indicates the one or more parameters input into the machine learning model, the output of the machine learning model, or any combination thereof, signaling that instructs the base station to transmit a reference signal to the first wireless device to evaluate whether the output of the machine learning model is accurate.

Aspect 14: The method of any of aspects 12 through 13, further comprising: transmitting the updated version of the machine learning model to the first wireless device.

Aspect 15: The method of any of aspects 12 through 14, further comprising: receiving, from one or more second wireless devices, signaling that indicates one or more second parameters input into respective machine learning models implemented at the one or more second wireless devices, one or more respective outputs of the respective machine learning models obtained by the one or more second wireless devices, or any combination thereof.

Aspect 16: The method of aspect 15, wherein determining the updated version of the machine learning model is further based at least in part on the one or more second parameters input into respective machine learning models implemented at the one or more second wireless devices, the one or more respective second outputs of the respective machine learning models obtained by the one or more second wireless devices, or any combination thereof.

Aspect 17: The method of any of aspects 15 through 16, wherein a first portion of the machine learning model is for a set of wireless devices that comprises the first wireless device, the one or more second wireless devices, and one or more additional wireless devices and a second portion of the machine learning model is for a subset of the set of wireless devices, the subset comprising the first wireless device and the one or more second wireless devices.

Aspect 18: The method of aspect 17, wherein the output of the machine learning model obtained by the first wireless device and the one or more respective second outputs of the respective machine learning models obtained by the one or more second wireless devices are each associated with the first portion of the machine learning model and each comprise an identifier associated with the base station.

Aspect 19: The method of any of aspects 17 through 18, further comprising: receiving, from the one or more additional wireless devices, signaling that indicates one or more third parameters input into respective machine learning models implemented at the one or more additional wireless devices, one or more respective third outputs of the respective machine learning models obtained by the one or more additional wireless devices, or any combination thereof, wherein determining the updated version of the machine learning model comprises: determining an updated version of the first portion of the machine learning model based at least in part on the one or more third parameters input into the respective machine learning models implemented at the one or more additional wireless devices, the one or more respective third outputs of the respective machine learning models obtained by the one or more additional wireless devices, or any combination thereof; and determining an updated version of the second portion of the machine learning model independent of the one or more third parameters input into respective machine learning models implemented at the one or more additional wireless devices, the one or more respective third outputs of the respective machine learning models obtained by the one or more additional wireless devices, or any combination thereof; transmitting the updated version of the first portion of the machine learning model to each wireless device of the set of wireless devices; and transmitting the updated version of the second portion of the machine learning model to each wireless device of the subset of the set of wireless devices.

Aspect 20: The method of any of aspects 12 through 19, wherein the one or more parameters comprise an energy waveform parameter for a signal received at the first wireless device over a duration, a date, a time, an uplink reception rate in one or more uplink symbols, a location of the first wireless device, a weather condition, a frequency resource or a time resource corresponding to a failed uplink transmission, or any combination thereof.

Aspect 21: The method of any of aspects 12 through 20, wherein the output of the machine learning model comprises an indication of whether the remote interference from the base station is present, one or more identifiers associated with one or more base stations causing remote interference, a distance between the first wireless device and the base station, a direction of the remote interference from the base station, a quantity of the one or more base stations causing remote interference, or any combination thereof.

Aspect 22: An apparatus for wireless communication at a first wireless device, comprising a processor; memory coupled with the processor; and instructions stored in the memory and executable by the processor to cause the apparatus to perform a method of any of aspects 1 through 11.

Aspect 23: An apparatus for wireless communication at a first wireless device, comprising at least one means for performing a method of any of aspects 1 through 11.

Aspect 24: A non-transitory computer-readable medium storing code for wireless communication at a first wireless device, the code comprising instructions executable by a processor to perform a method of any of aspects 1 through 11.

Aspect 25: An apparatus for wireless communication at a network node comprising a processor; memory coupled with the processor; and instructions stored in the memory and executable by the processor to cause the apparatus to perform a method of any of aspects 12 through 21.

Aspect 26: An apparatus for wireless communication at a network node comprising at least one means for performing a method of any of aspects 12 through 21.

Aspect 27: A non-transitory computer-readable medium storing code for wireless communication at a network node the code comprising instructions executable by a processor to perform a method of any of aspects 12 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as described herein, the phrase “a set” shall be construed as containing the possibility of a set with one member. That is, the phrase “a set” shall be construed in the same manner as “one or more” to support this interpretation.

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first wireless device, comprising:
a processor;
memory coupled with the processor; and
instructions stored in the memory and executable by the processor to cause the apparatus to:
receive, at the first wireless device from a network node, a machine learning model for use by the first wireless device to detect remote interference from a base station, wherein the first wireless device is associated with a first cell and the base station is associated with a second cell different from the first cell;
input, by the first wireless device, one or more parameters into the machine learning model; and
detect, by the first wireless device, whether the remote interference from the base station is present based at least in part on an output of the machine learning model, the output based at least in part on the one or more parameters input into the machine learning model.

2. The apparatus of claim 1, wherein the instructions are further executable by the processor to cause the apparatus to:
transmit, to the network node and after detecting whether the remote interference from the base station is present, one or more indications that indicate the one or more parameters input into the machine learning model, the output of the machine learning model, or any combination thereof.

3. The apparatus of claim 2, wherein the instructions are further executable by the processor to cause the apparatus to:
receive, after detecting whether the remote interference from the base station is present, a reference signal from the base station based at least in part on transmitting the one or more indications; and
determine whether the output of the machine learning model is accurate based at least in part on the reference signal.

4. The apparatus of claim 3, wherein the instructions are further executable by the processor to cause the apparatus to:
transmit, to the network node after determining whether the output of the machine learning model is accurate, an indication of whether the output of the machine learning model is accurate.

5. The apparatus of claim 1, wherein the instructions are further executable by the processor to cause the apparatus to:
receive, from the network node, an updated version of the machine learning model, the updated version of the machine learning model based at least in part on the one or more parameters input into the machine learning model, the output of the machine learning model, one or more second parameters input into respective machine learning models implemented at one or more second wireless devices, one or more respective second outputs of the respective machine learning models obtained by the one or more second wireless devices, or any combination thereof.

6. The apparatus of claim 1, wherein the instructions are further executable by the processor to cause the apparatus to:
select a time resource, a frequency resource, or both for an uplink transmission based at least in part on detecting whether the remote interference from the base station is present.

7. The apparatus of claim 1, wherein the one or more parameters comprise an energy waveform parameter for a signal received at the first wireless device over a duration, a date, a time, an uplink reception rate in one or more uplink symbols, a location of the first wireless device, a weather condition, a frequency resource or a time resource corresponding to a failed uplink transmission, or any combination thereof.

8. The apparatus of claim 7, wherein:
the one or more parameters comprises the energy waveform parameter for the signal; and
the duration comprises one or more symbols between a first time period for downlink signaling within the first cell and a next time period for downlink signaling within the first cell.

9. The apparatus of claim 7, wherein the one or more parameters comprises the energy waveform parameter for the signal, the energy waveform parameter comprising a slope of received power for the signal, an initial received power for the signal, or both.

10. The apparatus of claim 1, wherein the output of the machine learning model comprises an indication of whether the remote interference from the base station is present, one or more identifiers associated with one or more base stations causing remote interference, a distance between the first wireless device and the base station, a direction of the remote interference from the base station, a quantity of the one or more base stations causing remote interference, or any combination thereof.

11. The apparatus of claim 1, wherein the first wireless device comprises a base station that provides service within the first cell or a user equipment (UE) communicating within the first cell.

12. An apparatus, comprising:
a processor;
memory coupled with the processor; and
instructions stored in the memory and executable by the processor to cause the apparatus to:
transmit, to a first wireless device, a machine learning model for the first wireless device to detect remote interference from a base station, wherein the first wireless device is associated with a first cell and the base station is associated with a second cell different from the first cell;
receive, from the first wireless device, signaling that indicates one or more parameters input into the machine learning model by the first wireless device, an output of the machine learning model obtained by the first wireless device, or any combination thereof; and
determine an updated version of the machine learning model based at least in part on the one or more parameters input into the machine learning model by the first wireless device, the output of the machine learning model obtained by the first wireless device, or any combination thereof.

13. The apparatus of claim 12, wherein the instructions are further executable by the processor to cause the apparatus to:
transmit, to the base station and after receiving the signaling that indicates the one or more parameters input into the machine learning model, the output of the machine learning model, or any combination thereof, signaling that instructs the base station to transmit a reference signal to the first wireless device to evaluate whether the output of the machine learning model is accurate.

14. The apparatus of claim 12, wherein the instructions are further executable by the processor to cause the apparatus to:
transmit the updated version of the machine learning model to the first wireless device.

15. The apparatus of claim 12, wherein the instructions are further executable by the processor to cause the apparatus to:
receive, from one or more second wireless devices, signaling that indicates one or more second parameters input into respective machine learning models implemented at the one or more second wireless devices, one or more respective outputs of the respective machine learning models obtained by the one or more second wireless devices, or any combination thereof.

16. The apparatus of claim 15, wherein the instructions are further executable by the processor to cause the apparatus to:
determine the updated version of the machine learning model based at least in part on the one or more second parameters input into the respective machine learning models implemented at the one or more second wireless devices, the one or more respective second outputs of the respective machine learning models obtained by the one or more second wireless devices, or any combination thereof.

17. The apparatus of claim 15, wherein a first portion of the machine learning model is for a set of wireless devices that comprises the first wireless device, the one or more second wireless devices, and one or more additional wireless devices and a second portion of the machine learning model is for a subset of the set of wireless devices, the subset comprising the first wireless device and the one or more second wireless devices.

18. The apparatus of claim 17, wherein the output of the machine learning model obtained by the first wireless device and the one or more respective second outputs of the respective machine learning models obtained by the one or more second wireless devices are each associated with the first portion of the machine learning model and each comprise an identifier associated with the base station.

19. The apparatus of claim 17, wherein the instructions are further executable by the processor to cause the apparatus to:
receive, from the one or more additional wireless devices, signaling that indicates one or more third parameters input into respective machine learning models implemented at the one or more additional wireless devices, one or more respective third outputs of the respective machine learning models obtained by the one or more additional wireless devices, or any combination thereof, wherein, to determine the updated version of the machine learning model, the instructions are executable by the processor to cause the apparatus to:
determine an updated version of the first portion of the machine learning model based at least in part on the one or more third parameters input into the respective machine learning models implemented at the one or more additional wireless devices, the one or more respective third outputs of the respective machine learning models obtained by the one or more additional wireless devices, or any combination thereof; and
determine an updated version of the second portion of the machine learning model independent of the one or more third parameters input into the respective machine learning models implemented at the one or more additional wireless devices, the one or more respective third outputs of the respective machine learning models obtained by the one or more additional wireless devices, or any combination thereof;
transmit the updated version of the first portion of the machine learning model to each wireless device of the set of wireless devices; and
transmit the updated version of the second portion of the machine learning model to each wireless device of the subset of the set of wireless devices.

20. The apparatus of claim 12, wherein the one or more parameters comprise an energy waveform parameter for a signal received at the first wireless device over a duration, a date, a time, an uplink reception rate in one or more uplink symbols, a location of the first wireless device, a weather condition, a frequency resource or a time resource corresponding to a failed uplink transmission, or any combination thereof.

21. The apparatus of claim 12, wherein the output of the machine learning model comprises an indication of whether the remote interference from the base station is present, one or more identifiers associated with one or more base stations causing remote interference, a distance between the first wireless device and the base station, a direction of the remote interference from the base station, a quantity of the one or more base stations causing remote interference, or any combination thereof.

22. A method for wireless communication at a first wireless device, comprising:
receiving, at the first wireless device from a network node, a machine learning model for use by the first wireless device to detect remote interference from a base station, wherein the first wireless device is associated with a first cell and the base station is associated with a second cell different from the first cell;
inputting, by the first wireless device, one or more parameters into the machine learning model; and
detecting, by the first wireless device, whether the remote interference from the base station is present based at least in part on an output of the machine learning model, the output based at least in part on the one or more parameters input into the machine learning model.

23. The method of claim 22, further comprising:
transmitting, to the network node and after detecting whether the remote interference from the base station is present, one or more indications that indicate the one or more parameters input into the machine learning model, the output of the machine learning model, or any combination thereof.

24. The method of claim 23, further comprising:
receiving, after detecting whether the remote interference from the base station is present, a reference signal from the base station based at least in part on transmitting the one or more indications; and
determining whether the output of the machine learning model is accurate based at least in part on the reference signal.

25. The method of claim 22, further comprising:
receiving, from the network node, an updated version of the machine learning model, the updated version of the machine learning model based at least in part on the one or 3 more parameters input into the machine learning model, the output of the machine learning model, one or more second parameters input into respective machine learning models implemented at one or more second wireless devices, one or more respective second outputs of the respective machine learning models obtained by the one or more second wireless devices, or any combination thereof.

26. The method of claim 22, further comprising:
selecting a time resource, a frequency resource, or both for an uplink transmission based at least in part on detecting whether the remote interference from the base station is present.

27. A method at a network node of a wireless communications network, the method comprising:
transmitting, to a first wireless device, a machine learning model for the first wireless device to detect remote interference from a base station, wherein the first wireless device is associated with a first cell and the base station is associated with a second cell different from the first cell;
receiving, from the first wireless device, signaling that indicates one or more parameters input into the machine learning model by the first wireless device, an output of the machine learning model obtained by the first wireless device, or any combination thereof; and
determining an updated version of the machine learning model based at least in part on the one or more parameters input into the machine learning model by the first wireless device, the output of the machine learning model obtained by the first wireless device, or any combination thereof.

28. The method of claim 27, further comprising:
transmitting, to the base station and after receiving the signaling that indicates the one or more parameters input into the machine learning model, the output of the machine learning model, or any combination thereof, signaling that instructs the base station to transmit a reference signal to the first wireless device to evaluate whether the output of the machine learning model is accurate.

29. The method of claim 27, further comprising:
transmitting the updated version of the machine learning model to the first wireless device.

30. The method of claim 27, further comprising:
receiving, from one or more second wireless devices, signaling that indicates one or more second parameters input into respective machine learning models implemented at the one or more second wireless devices, one or more respective outputs of the respective machine learning models obtained by the one or more second wireless devices, or any combination thereof.
